(19) United States
(12) Patent Application Publication
(10) Pub. No.: US 2024/0320620 A1
(43) Pub. Date: Sep. 26, 2024

(54) HANDLING SYSTEM, INFORMATION PROCESSING DEVICE, METHOD, STORAGE MEDIUM, AND INFORMATION PROCESSING SYSTEM

(71) Applicant: Kabushiki Kaisha Toshiba, Tokyo (JP)

(72) Inventors: Seiji TOKURA, Kawasaki (JP); Kazuhide SAWA, Kawasaki (JP); Akihito OGAWA, Fujisawa (JP); Kazunobu KONDA, Suginami (JP)

(73) Assignee: Kabushiki Kaisha Toshiba, Tokyo (JP)

(21) Appl. No.: 18/607,716

(22) Filed: Mar. 18, 2024

(30) Foreign Application Priority Data
Mar. 20, 2023 (JP) 2023-043832

(51) Int. Cl. G06Q 10/087

(52) U.S. Cl. CPC G06Q 10/087

(57) ABSTRACT

According to an embodiment, a handling system that handles an object is provided. The handling system has a holding unit, a storage unit, and a processing unit. The holding unit holds the object. The storage unit stores operation setting information and operation history information. The operation setting information associates first information entailed in the holding operation in which the holding unit holds the object, with second information including an operation setting for operating the holding unit. The operation history information includes operation records of the holding unit. The processing unit controls an operation of the holding unit on the basis of the operation setting information. The processing unit updates the operation history information on the basis of operation records of the operation. The processing unit determines whether to update the operation setting information on the basis of the updated operation history information.

### CROSS-REFERENCE TO RELATED APPLICATION

This application is based upon and claims the benefit of priority from Japanese Patent Application No. 2023-043832, filed Mar. 20, 2023; the entire contents of which are incorporated herein by reference.

### FIELD

Embodiments of the present invention relate to a handling system, an information processing device, a method, a non-transitory computer readable storage medium for storing a program, and an information processing system.

### BACKGROUND

At a distribution site, and the like, a picking operation of picking up one or more articles from a storage location and transporting them to another area is performed according to an order of a specified article. A picking device that performs picking is known.

### BRIEF DESCRIPTION OF THE DRAWINGS

FIG. 1 is a schematic diagram which shows an overall configuration of a picking system 1 according to a first embodiment.

FIG. 2 is a block diagram which shows a functional configuration of the picking system 1 according to the first embodiment.

FIG. 3 is a diagram which shows a data structure of an operation history DB 440 according to the first embodiment.

FIG. 4 is a diagram which shows a data structure of an item DB 442 according to the first embodiment.

FIG. 5 is a diagram which shows a data structure of a robot DB 444 according to the first embodiment.

FIG. 6 is a diagram which shows a data structure of an operation setting DB 446 according to the first embodiment.

FIG. 7 is a flowchart which shows an overall flow of a picking operation of a picking system 1 according to the first embodiment.

FIG. 8 is a flowchart which shows processing in which an operation setting update unit 466 according to the first embodiment updates the operation setting DB 446.

FIG. 9 is a flowchart which shows processing in which an update target determination unit 464 according to the first embodiment determines an update target.

FIG. 10 is a diagram which shows an example of a screen displayed on a display unit 580 according to the first embodiment.

FIG. 11 is a flowchart which shows processing in which an update target determination unit 464 according to a second embodiment determines an update target.

### DETAILED DESCRIPTION

A handling system of the embodiment is a handling system that handles an object. The handling system has a holding unit, a storage unit, and a processing unit. The holding unit holds the object. The storage unit stores operation setting information and operation history information. The operation setting information associates first information entailed in the holding operation in which the holding unit holds the object, with second information including an operation setting for operating the holding unit. The operation history information includes operation records of the holding unit. The processing unit controls an operation of the holding unit on the basis of the operation setting information. The processing unit updates the operation history information on the basis of operation records of the operation. The processing unit determines whether to update the operation setting information on the basis of the updated operation history information.

Hereinafter, a handling system, an information processing device, a method, a storage medium, an information processing system, and a data structure of embodiments will be described with reference to the drawings. Note that the drawings are schematic or conceptual, and a relationship of respective parts in thickness and width, a size ratio between parts, and the like are not necessarily the same as those in reality. In addition, even in a case in which the same part is shown, the dimension and ratio may be shown differently in different drawings. Moreover, XYZ coordinates shown in the drawings are defined for convenience of description and do not limit the invention.

In the present specification, “based on XX” means “based on at least XX” and includes cases where it is based on another element in addition to XX. Furthermore, “based on XX” is not limited to a case where XX is directly used, but also includes a case of being based on arithmetic calculations or processing performed on XX. “XX” is an arbitrary element (for example, information).

### First Embodiment

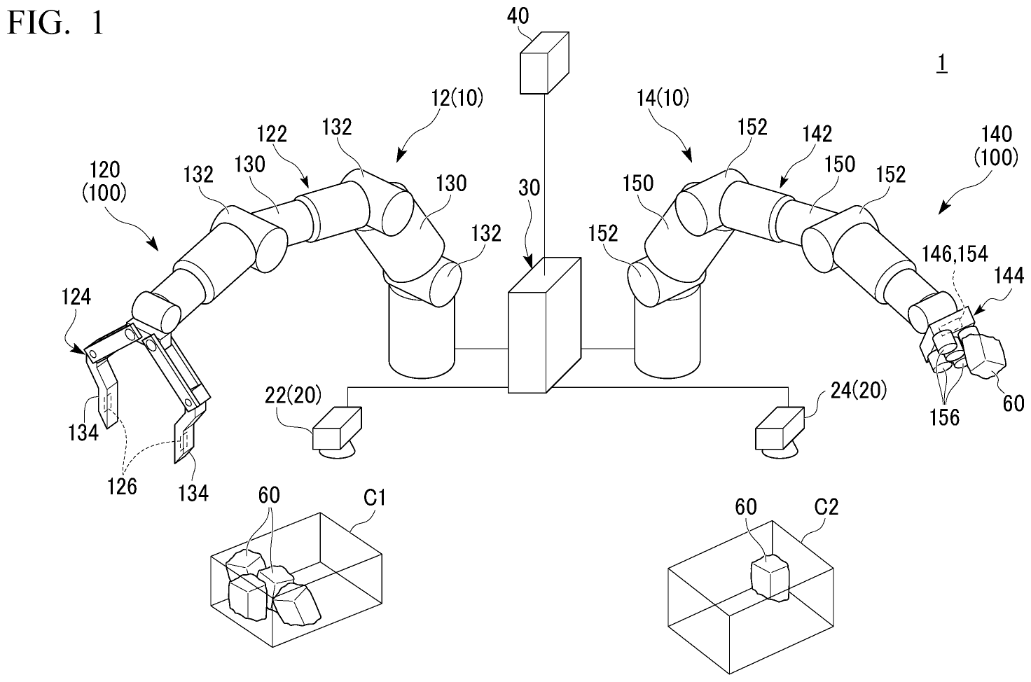

A picking system 1 (an example of a “handling system”) according to a first embodiment will be described with reference to FIGS. 1 to 10.

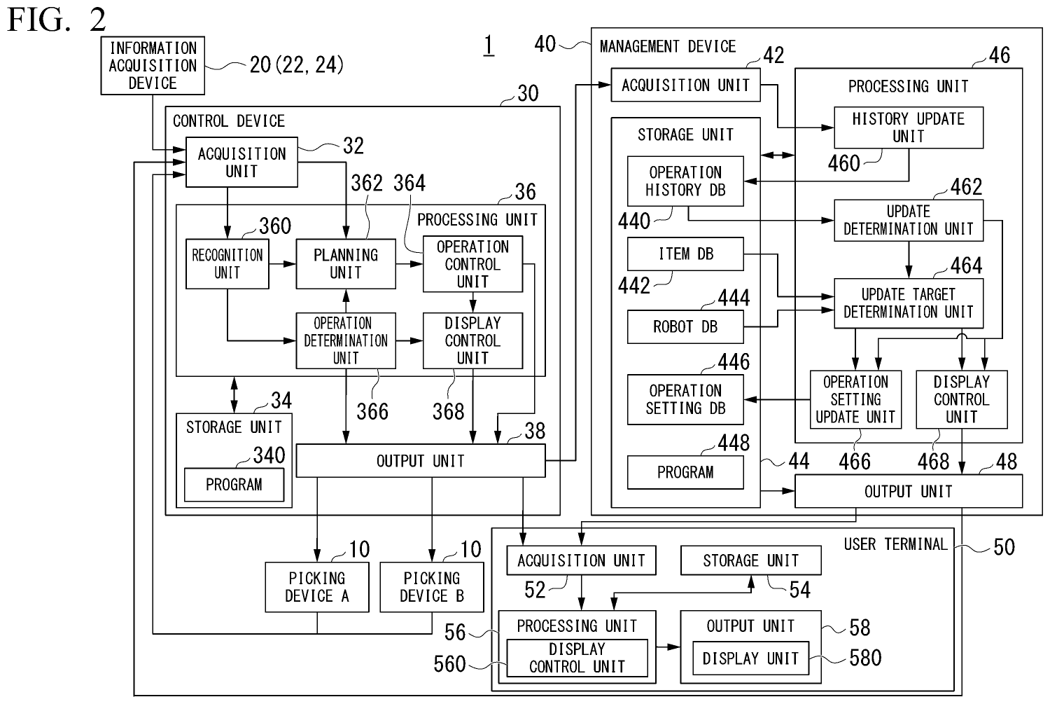

First, an overall configuration of the picking system 1 will be overviewed with reference to FIGS. 1 and 2.

FIG. 1 is a schematic diagram which shows an overall configuration of the picking system 1 according to the first embodiment.

FIG. 2 is a block diagram which shows a functional configuration of the picking system 1 according to the first embodiment.

The picking system 1 is an example of a handling system for performing a handling operation of handling one or more objects. Although the picking system 1 for picking one or more items 60 (an example of an “object”) will be described below, the handling system according to the present embodiment is not limited to a picking system for distribution. The handling system can be widely applied to industrial robot systems and other systems. In the present specification, a “handling system” and a “handling device” are not limited to a system or a device whose main purpose is to transport objects, but include a system and a device that transport (move) objects as part of product assembly or other purposes.

The picking system 1 performs a picking operation (an example of the “handling operation”), such as a pick-up operation for distribution, a transport operation, and a release operation. For example, as shown in FIG. 1, the picking system 1 moves the item 60 located in a first housing unit C1 specified as a transport source to a second housing unit C2 specified as a transport destination. For example, the picking system 1 performs a task of picking out a specified number of one or more types of the item 60 stored in the first housing unit C1 or the like and loading them onto the second housing unit C2.

The first housing unit C1 is, for example, any of various types of conveyors, various types of pallets, or a container such as a tote or an Oricon. The term “container” broadly refers to a member that can accommodate the item 60 (for example, a box-shaped member). However, the first housing unit C1 is not limited to the example described above.

One or more items 60 are randomly placed in the first housing unit C1. The first housing unit C1 may accommodate one or more items 60 of the same type, or may accommodate one or more items 60 of two or more types. An external shape of the item 60 may vary from a small size such as 5 cm square to a large size such as 30 cm square. The item 60 varies from a light weight of several tens of grams to a heavy weight of several kilograms. However, the size and weight of the item 60 are not limited to the example described above.

The second housing unit C2 is, for example, a container such as a tote or an Oricon. However, the second housing unit C2 is not limited to the example described above. For example, the picking system 1 may move the item 60 to the second housing unit C2 instead of the container. In the following description, the “first housing unit C1” and the “second housing unit C2” may simply be collectively referred to as “housing units C1 and C2.”

As shown in FIG. 1, the picking system 1 includes a picking device 10 (an example of the “handling device”), an information acquisition device 20, a control device 30, a management device 40, and a user terminal 50. The control device 30, the management device 40, and the user terminal 50 form an information processing system each individually or in cooperation. That is, each of the control device 30, the management device 40, and the user terminal 50 is an example of the “information processing device” and an example of the “information processing system.” Any combination of these is an example of the “information processing system.” Here, a system such as a “picking system,” a “handling system,” an “information processing system,” or the like in the present specification consists of one or more devices or components. Therefore, the “picking system,” the “handling system,” and the “information processing system” are not limited to constituents consisting of two or more devices. The picking system or handling system may be configured from a single picking device or handling device (for example, a picking device or handling device incorporating a sensor, a control device, or the like).

As shown in FIG. 2, the picking system 1 can have two or more picking devices 10 (a picking device A and a picking device B). However, the picking system 1 may include only one picking device 10.

First, the picking device 10 will be described. The picking device 10 is, for example, a robot device. As shown in FIG. 1, the picking device 10 holds the item 60 located in the first housing unit C1 and moves the held item 60 to the second housing unit C2. The picking device 10 can communicate with the control device 30, the management device 40, and the user terminal 50 by wire or wirelessly. In the present embodiment, the picking device 10 has a first picking hand 12 and a second picking hand 14.

The first picking hand 12 functions as a pinching unit 120 (an example of the “holding unit”). The first picking hand 12 includes, for example, a first movable arm 122, a pinching hand 124 provided at a tip of the first movable arm 122, and a pinching unit sensor 126 provided on the pinching hand 124.

The first movable arm 122 is a moving mechanism that moves the pinching hand 124 to a desired position. The first movable arm 122 is, for example, a six-axis vertically articulated robot arm. The first movable arm 122 can assume various positions and postures. Similar to a human arm or hand, the first movable arm 122 can also assume various postures for holding objects. The first movable arm 122 includes, for example, a plurality of arm members 130 and a plurality of rotation parts 132 that rotatably connect the plurality of arm members 130.

A configuration of the first movable arm 122 is not particularly limited, and it may be a three-axis orthogonal robot arm, or may be a mechanism for moving the pinching hand 124 to a desired position using other constituents. For example, the first movable arm 122 may be a flying object (for example, a drone) that lifts and moves the pinching hand 124 using rotary wings.

The pinching hand 124 is a holding mechanism (end effector) that holds the item 60 located in the first housing unit C1.

The pinching hand 124 has two or more pinching claws 134 for holding the item 60. For example, the pinching hand 124 is a gripper type hand that grips the item 60 between two fingers. A configuration of the pinching hand 124 is not limited to this, and it may be, for example, a gripper type hand that grips the item 60 with three or four fingers.

Note that the pinching hand 124 may be a hybrid type hand that further includes a suction device and an adsorption pad communicating with the suction device. In this case, the pinching hand 124 can hold the item 60 by pinching and/or adsorption. The adsorption pad can be provided at a fingertip of the pinching hand 124. A plurality of adsorption units may be provided at the fingertip of the pinching hand 124. Alternatively, a hybrid type hand having a pinching hand and an adsorption hand oriented in different directions (for example, opposite directions) may be used. In addition, the configuration of the pinching hand 124 is not particularly limited.

The pinching unit sensor 126 detects a state of the pinching unit 120. For example, the pinching unit sensor 126 is a sensor provided at or near the pinching hand 124 (for example, inside the pinching claw 134). The pinching unit sensor 126 acquires, for example, information on a physical state of the pinching hand 124, such as distortion and a surface condition of the pinching claw 134, and a pressure applied to the pinching claw 134. The pinching unit sensor 126 includes, for example, one or more physical sensors, such as a distortion sensor, a pressure sensor, and a near contact sensor. The pinching unit sensor 126 may further acquire physical information of the item 60.

The pinching unit sensor 126 is connected to the control device 30 by wire or wirelessly, and transmits a result of the detection to the control device 30. The pinching unit sensor 126 may be provided as a part of the picking device 10 or may be provided as a separate member attachable to the picking device 10.

The second picking hand 14 functions as an adsorption unit 140 (an example of the “holding unit”). The second picking hand 14 includes, for example, a second movable arm 142, an adsorption hand 144 provided at a tip of the second movable arm 142, and an adsorption unit sensor 146 provided on the adsorption hand 144. The second movable arm 142 of the second picking hand 14 has an arm member 150 and a rotation part 152, similarly to the first movable arm 122 of the first picking hand 12.

The adsorption hand 144 is a holding mechanism (an end effector) that holds the item 60 located in the first housing unit C1. For example, the adsorption hand 144 holds the item 60 by adsorption. The adsorption hand 144 includes a suction device 154 and an adsorption pad 156 communicating with the suction device 154.

The suction device 154 is, for example, a vacuum pump. The suction device 154 communicates with each of a plurality of adsorption pads 156 via a hose or the like. In a case in which the suction device 154 is driven, a pressure within each adsorption pad 156 becomes lower than atmospheric pressure. As a result, the adsorption pad 156 can adsorb and hold the item 60.

The adsorption pad 156 is provided at a tip of the adsorption hand 144. For example, a plurality of adsorption pads 156 are provided at the tip of the adsorption hand 144. At least one of the adsorption pads 156 has an outer shape smaller than the smallest item 60 located in the first housing unit C1. The second picking hand 14 can adsorb and hold the item 60 using only one or more adsorption pads 156 selected from the plurality of adsorption pads 156.

The adsorption unit sensor 146 is a sensor provided on the adsorption hand 144 (for example, inside the adsorption hand 144) or near the adsorption hand 144. The adsorption unit sensor 146 acquires, for example, information on a physical state of the adsorption hand 144, such as an internal pressure of the adsorption pad 156, a surface state of the adsorption pad 156, and an operating state of the suction device 154. The adsorption unit sensor 146 includes, for example, one or more physical sensors, such as a pressure sensor, a distortion sensor, or a near contact sensor. The adsorption unit sensor 146 may also acquire physical information of the item 60.

The adsorption unit sensor 146 is connected to the control device 30 by wire or wirelessly, and transmits a result of the detection to the control device 30. The adsorption unit sensor 146 may be provided as a part of the picking device 10 or may be provided as a separate member that can be attached to the picking device 10.

In the following description, the “pinching unit 120” and the “adsorption unit 140” are collectively referred to as the “holding unit 100.” That is, the “holding unit 100” is assumed to include the “pinching unit 120” and the “adsorption unit 140.” Although the picking device 10 including the pinching unit 120 and the adsorption unit 140 has been described here as an example, a configuration of the holding unit 100 is not limited to including one pinching unit 120 and one adsorption unit 140 as described above. For example, the holding unit 100 may be configured from two or more pinching hands, or may be configured from two or more adsorption hands. In this case, the holding unit 100 may also be configured to have a plurality of pinching type hands that differ in at least one of characteristics such as a configuration, a structure, a shape, a dimension, and an arrangement. Specifically, the holding unit 100 may be configured from two or more pinching hands with different claw lengths and opening widths. Alternatively, the holding unit 100 may be configured to have two or more adsorption hands that differ in at least one of the characteristics, such as a configuration, a structure, a shape, a dimension, and an arrangement. Specifically, the holding unit 100 may be configured from two or more adsorption hands that differ in an arrangement of adsorption pads, a diameter of the adsorption pads, a structure of the bellows, and the like. Even in these cases, it is possible to perform the same handling operation as in the embodiment described above and to obtain the same effect.

In addition to the pinching unit 120 and the adsorption unit 140, or instead of the pinching unit 120 and/or the adsorption unit 140, the picking device 10 may have a mechanism for holding the item 60 by a holding method other than pinching and adsorption. For example, the picking device 10 may include a holding unit that holds the item 60 using magnetic force. Alternatively, the picking device 10 is a holding unit configured from a flexible membrane packed with powder and a vacuum pump that extracts air from inside the flexible membrane, and may be a holding unit (for example, a jamming gripper) that can hold the item 60 by using a jamming phenomenon. The picking device 10 is not limited to a configuration of the robot arm as described above, but can be of any configuration such as a crane or a drone.

Next, the information acquisition device 20 will be described. The information acquisition device 20 acquires information on the item 60 accommodated in the first housing unit C1 and the second housing unit C2. Specifically, the information acquisition device 20 includes a first housing unit sensor 22 and a second housing unit sensor 24. The housing unit sensors 22 and 24 are connected to the control device 30 by wire or wirelessly, and transmit results of detection to the control device 30. The housing unit sensors 22 and 24 do not necessarily have to be separate sensors, and a single sensor may function as both the first housing unit sensor 22 and the second housing unit sensor 24.

The first housing unit sensor 22 is a light amount sensor such as a camera or any of various sensors arranged near the first housing unit C1 (for example, directly above or diagonally above the first housing unit C1). The first housing unit sensor 22 acquires, for example, information on the item 60 located in the first housing unit C1 and information on the first housing unit C1. The information acquired by the first housing unit sensor 22 is, for example, image data, distance image data, shape data, and the like. “Distance image data” is image data that has distance information in one or more directions (for example, depth information from an arbitrary reference plane set above the first housing unit C1). “Shape data” is information indicating an external shape of the item 60, or the like. Information detected by the first housing unit sensor 22 is output to the control device 30. Note that the first housing unit sensor 22 may be provided as a part of the picking device 10.

The second housing unit sensor 24 is a camera or any of various sensors arranged near the second housing unit C2 (for example, directly above or diagonally above the second housing unit C2). The second housing unit sensor 24 detects, for example, information on a shape of the second housing unit C2 (including a shape of the inner wall surface or partition) and information on the item 60 placed in the second housing unit C2. The information acquired by the second housing unit sensor 24 is, for example, image data, distance image data, shape data, and the like. Information detected by the second housing unit sensor 24 is output to the control device 30. Note that the second housing unit sensor 24 may be provided as a part of the picking device 10.

Next, the control device 30 will be described. The control device 30 controls the picking device 10. For example, as shown in FIG. 2, the control device 30 acquires information detected by various sensors 22, 24, 126, and 146, and controls the picking device 10 on the basis of the acquired information. The control device 30 is, for example, an information processing device (computer) that is equipped with, for example, a processor, a memory, a storage, and the like and capable of executing a program. The control device 30 is connected to the picking device 10 and various sensors 22, 24, 126, and 146 by wire or wirelessly.

As shown in FIG. 2, the control device 30 includes an acquisition unit 32, a storage unit 34, a processing unit 36, and an output unit 38 as its functional units. The control device 30 may be mounted as a separate constituent from the picking device 10 or may be mounted as a part of the picking device 10. A part of the functional constituents of the control device 30 may be realized by other devices such as a control unit embedded in the picking device 10, the management device 40, and the user terminal 50.

The acquisition unit 32 receives an input operation from a user and an input signal from a management entity such as the management device 40 or a higher management system (for example, an external system), and acquires order information including a list of items 60 to be picked, operation setting information for picking operation, and the like. Moreover, the acquisition unit 32 acquires sensing information including results of detection from the first housing unit sensor 22, the second housing unit sensor 24, the pinching unit sensor 126, and the adsorption unit sensor 146.

The storage unit 34 is configured to include a memory and a storage, and stores any information. For example, the storage unit 34 stores, in addition to a program 340 that causes a processor of the control device 30 to execute a predetermined command, order information on the item 60 to be picked, a picking list for each type of the item 60 generated based on the order information, information on the first housing unit C1 and the second housing unit C2, information on the item 60, various types of data acquired from various sensors, results of arithmetic calculation processing by the processing unit 36, and the like.

The processing unit 36 is configured to include a processor, and performs predetermined arithmetic calculation processing on an input received by the acquisition unit 32. The processing unit 36 includes a recognition unit 360, a planning unit 362, an operation control unit 364, an operation determination unit 366, and a display control unit 368 as its functional constituents.

The recognition unit 360 performs recognition processing on the basis of sensing information from various sensors. For example, the recognition unit 360 may process information acquired by the first housing unit sensor 22 and the second housing unit sensor 24. Specifically, the recognition unit 360 recognizes the first housing unit C1 and each item 60 in the first housing unit C1 on the basis of two-dimensional image data and/or distance image data acquired by the first housing unit sensor 22. More specifically, the recognition unit 360 can determine a position, a shape, and the like of the first housing unit C1, and can also determine a type, a position, an orientation, a shape, characteristics, and the like of each item 60 in the first housing unit C1. The recognition unit 360 may also use information on the item 60 included in an item database 442, which will be described below, in the recognition processing described above.

Similarly, the recognition unit 360 can recognize the second housing unit C2 and each item 60 in the second housing unit C2 on the basis of two-dimensional image data and/or distance image data acquired by the second housing unit sensor 24. Specifically, the recognition unit 360 can determine a position, a shape, and the like of the second housing unit C2, and can also determine a position, an orientation, a shape, characteristics, and the like of the item 60 in the second housing unit C2. More specifically, the recognition unit 360 can determine an arrangement of each item 60 in the first housing unit C1 or the second housing unit C2 (a horizontal placement, a vertical placement, a diagonal placement, a random placement) based on the two-dimensional image data and/or distance image data. The recognition unit 360 can deliver such recognition results to the planning unit 362, the operation determination unit 366, and the like as recognition information.

The planning unit 362 generates a picking plan for picking, by the holding unit 100 of the picking device 10, the item 60 on the basis of the order information and the operation setting information acquired by the acquisition unit 32 from the management device 40, results of recognition by the recognition unit 360, and the like. The picking plan is a plan for a picking operation of the item 60 by holding unit 100. The picking operation includes, for example, a pick-up operation that holds and lifts the item 60 in the first housing unit C1, a transport operation that transports the item 60 while holding it, and a release operation that releases the item 60 into the second housing unit C2. For example, the picking plan includes information on a route that the holding unit 100 takes to pick up the item 60 in the first housing unit C1, information on a position and a posture of the holding unit 100 in a case in which it picks up the item 60, information on a route for transporting the item 60 to the second housing unit C2 after picking up the item 60, information on the position and the posture of the holding unit 100 in a case in which it releases the item 60, and the like.

The planning unit 362 can apply the operation setting information (for example, a moving speed and acceleration of the holding unit 100 for each operation, a via-point pattern of the route, and the like) acquired from the management device 40 by the acquisition unit 32 as a default setting for operation control of the holding unit 100. The planning unit 362 can adjust the operation setting information as a default setting as appropriate according to the results of the recognition by the recognition unit 360. As a result, the planning unit 362 can optimize various operation control parameters depending on a situation.

The planning unit 362 may calculate a plurality of routes or positions and postures and determine a priority of the routes or positions and postures by scoring. For example, the planning unit 362 may generate a picking plan on the basis of a route or a position and a posture with the highest score. The planning unit 362 can deliver the generated picking plan to the operation control unit 364 as operation plan information.

The operation control unit 364 controls the operation of the picking device 10 on the basis of position posture information and route information in the picking plan generated by the planning unit 362. For example, the operation control unit 364 controls operations of the first movable arm 122, the pinching hand 124, the second movable arm 142, and the adsorption hand 144 by driving a power source such as a motor provided in the picking device 10. As a result, the operation control unit 364 can move the holding unit 100 according to the position posture information and the route information, and execute the picking operation of the item 60. Regarding the operation control of the adsorption unit 140, the operation control unit 364 drives the suction device 154 in a case in which it picks up the item 60 in the first housing unit C1, and stops the driving of the suction device 154 in a case in which it releases the transported item 60 in the second housing unit C2. The operation control unit 364 can deliver operation control information to the display control unit 368, the output unit 38, and the like. The operation control information is transmitted to the picking device 10 via the output unit 38.

The operation determination unit 366 performs various determinations in the picking processing. For example, the operation determination unit 366 determines a result of the picking plan generation processing by the planning unit 362. Specifically, the operation determination unit 366 can determine that the picking plan generation by the planning unit 362 has failed in a case in which a picking plan generated by the planning unit 362 includes an inappropriate route (for example, a route in which the holding unit 100 collides with the first housing unit C1).

For example, the operation determination unit 366 determines a result of executing a picking operation (that is, a pick-up operation, a transport operation, and a release operation of the item 60) by the holding unit 100. Specifically, the operation determination unit 366 can evaluate the picking operation of the holding unit 100 on the basis of sensing information of the holding state sensor (that is, the pinching unit sensor 126 or the adsorption unit sensor 146) of the holding unit 100.

For example, the recognition unit 360 can recognize that the item 60 has been released from the holding unit 100 in the second housing unit C2 on the basis of the sensing information of the pinching unit sensor 126 or the adsorption unit sensor 146 and/or the sensing information of the second housing unit sensor 24. In this case, the operation determination unit 366 can determine that the picking operation of the item 60 by the holding unit 100 has succeeded.

For example, the recognition unit 360 can recognize that the item 60 has left from the holding unit 100 in the first housing unit C1 within a predetermined time after the pick-up operation of the holding unit 100 on the basis of sensing information from the pinching unit sensor 126 or the adsorption unit sensor 146. Alternatively, the recognition unit 360 can recognize that the item 60 has dropped into the first housing unit C1 within a predetermined time from the pick-up operation of the holding unit 100 on the basis of the sensing information of the first housing unit sensor 22. In these cases, the operation determination unit 366 may determine that the pick-up operation of the item 60 by the holding unit 100 has failed.

To describe more specifically using the adsorption unit 140 as an example, for example, in a case in which there is no change in pressure inside the adsorption unit 140 output from the adsorption unit sensor 146 before and after the pick-up operation, the operation determination unit 366 determines that the adsorption unit 140 is unable to adsorb the item 60 and has failed in the pick-up operation. In addition, in a case in which the pressure inside the adsorption unit 140 decreases during the pick-up operation and then immediately returns to the pressure before the pick-up operation, the operation determination unit 366 determines that although the adsorption unit 140 temporarily adsorbed the item 60, the item 60 drops immediately and the pick-up operation has failed. On the other hand, in a case in which the pressure inside the adsorption unit 140 decreases before and after the pick-up operation, and the decreased pressure value is maintained thereafter, the operation determination unit 366 determines that the adsorption unit 140 is able to properly adsorb the item 60 and the pick-up operation has succeeded.

For example, the recognition unit 360 can recognize that the item 60 held by the holding unit 100 has left from the holding unit 100 on the basis of the sensing information of the pinching unit sensor 126 or the adsorption unit sensor 146. In this case, the operation determination unit 366 can determine that the item 60 has dropped from the holding unit 100 while the item 60 is being transported (that is, the transport operation of the holding unit 100 has failed). The operation determination unit 366 can determine whether a dropping position of the item 60 is inside the first housing unit C1, inside the second housing unit C2, or outside the housing units C1 and C2 on the basis of the sensing information of the first housing unit sensor 22 and the second housing unit sensor 24.

To explain more specifically using the adsorption unit 140 as an example, for example, the operation determination unit 366 periodically refers to a result of an output from the adsorption unit sensor 146 during the transport operation of the adsorption unit 140 and monitors internal pressure of the adsorption unit 140. For example, in a case in which the adsorption unit sensor 146 has detected an increase in the pressure inside the adsorption unit 140 during the transport operation, the operation determination unit 366 can determine that a holding state in which the item 60 is held by the adsorption unit 140 has changed, and estimate that the transported item 60 has left from the adsorption unit 140 and has dropped.

For example, the operation determination unit 366 can determine whether the item 60 has dropped on the basis of one or more of the following indicators. However, indicators other than these can also be used.
(1) A decrease in suction force in a case in which the item 60 is adsorbed.
(2) Results of detection by a contact sensor provided in the pinching unit 120
(3) Results of detection by a pressure sensing sensor installed in the pinching unit 120
(4) Distance to the item 60 detected by a distance measuring sensor provided in the holding unit 100
(5) Presence or absence of the item 60 held in the holding unit 100 detected by an image sensor
(6) Results of detection by a weight sensor provided in the holding unit 100
(7) Results of detection by a weight sensor on a floor
(8) Results of detection by a weight sensor of the first housing unit C1 or the second housing unit C2
(9) Vibration of the item 60 detected by force sensor provided in the holding unit 100
(10) Detection results of a pressure sensing sensor on the floor
(11) A dropping sound detected by microphone
(12) Presence or absence of the item 60 outside a normal area detected by an image sensor (in a case in which the item 60 is outside the normal area, it is determined that the item 60 has dropped)

For example, the recognition unit 360 can recognize a sign indicating that the item 60 will leave the holding unit 100 on the basis of the sensing information of the pinching unit sensor 126 or the adsorption unit sensor 146. For example, in a case in which the pinching unit sensor 126 detects displacement of the item 60 with respect to the pinching claw 134 or in a case in which the adsorption unit sensor 146 detects an increase in internal pressure of the adsorption unit 140, in a case in which the recognition unit 360 has recognized that the item 60 has not left from the holding unit 100, the operation determination unit 366 can determine that there is a sign indicating that the item 60 will leave the holding unit 100.

For example, the operation determination unit 366 can determine a sign of failure on the basis of one or more of the following indicators. However, indicators other than these can also be used.
(1) Amount of decrease in suction force in a case in which the item 60 is adsorbed
(2) Amount of change in width between pinching claws 134 in a case in which the item 60 is pinched
(3) Change in results of the detection by the pinching unit sensor 126 (for example, a pressure sensing sensor) in a case in which the item 60 is pinched
(4) Change in posture of the item 60 held in the holding unit 100
(4-1) Change in distance to the item 60 detected by the distance measuring sensor provided in the holding unit 100
(4-2) Change in posture of the item 60 held in the holding unit 100 detected by an image sensor
(4-3) Change in center of gravity position of the item 60 detected by holding state sensors 126 and 146
(5) Vibration of the item 60 detected by the holding state sensors 126 and 146
(6) Vibration of the item 60 detected by an image sensor

In this manner, the operation determination unit 366 determines success or failure of the picking operation, a situation at the time of failure, and a presence or absence of a sign on the basis of the sensing information from the various sensors 22, 24, 126, and 146 and/or the recognition information from the recognition unit 360. For example, the operation determination unit 366 can classify a result of the picking operation into “success,” “success (with a sign of failure),” “failure: pick up failure,” “failure: drop,” and the like. The operation determination unit 366 can deliver such a determination result to the planning unit 362, the display control unit 368, the output unit 38, and the like as operation determination information. The operation determination unit 366 may include one or more of the indicators listed above in the operation determination information as items indicating a result of the picking.

For example, the planning unit 362 may retry generating a picking plan in response to a result of the determination that the generation of a picking plan has failed. Moreover, the planning unit 362 can generate an operation plan for retrying a picking operation in response to a result of the determination that the picking operation has failed. The operation control unit 364 can generate operation control information for controlling the picking device 10 such that it retries the picking operation in response to reception of such a retry operation plan from the planning unit 362.

Note that determination content of the operation determination unit 366 is not limited to the example described above. For example, the operation determination unit 366 can perform various types of determination processing, such as determining whether recognition processing by the recognition unit 360 has succeeded. In a case in which the operation determination unit 366 determines that the recognition unit 360 has failed in the recognition processing, the recognition unit 360 can retry the recognition processing in response to this determination result.

In a case in which the operation determination unit 366 determines that the item 60 has dropped, it may further determine a cause of the drop. For example, the operation determination unit 366 can determine whether the drop is due to the moving speed or acceleration of the holding unit 100. The operation determination unit 366 can make such a determination on the basis of, for example, a result of detection by the weight sensor of the first housing unit C1 or the second housing unit C2, an input of the user, and the like.

The display control unit 368 generates display control information for presenting a result of an arithmetic calculation by the processing unit 36 to the user. The display control information is used, for example, to display visual information on the user terminal 50. Note that devices other than the user terminal 50 (the picking device 10, the control device 30, the management device 40, and the like) may display the visual information on the basis of this display control information. For example, the display control unit 368 generates, on the basis of the operation control information received from the operation control unit 364, the operation determination information received from the operation determination unit 366, and the like, display control information for outputting a visual display where these types of information are reflected.

The output unit 38 is configured to include an input or output interface, and outputs the result of arithmetic calculation processing in the processing unit 36. For example, the output unit 38 outputs a control signal, a motor drive signal, or the like of the picking device 10 on the basis of the operation control information received from the operation control unit 364. For example, the output unit 38 generates operation records by associating the operation determination information received from the operation determination unit 366 with past operation control information corresponding to a corresponding operation. The output unit 38 outputs the generated operation records to the management device 40. For example, the output unit 38 outputs display control information received from the display control unit 368 to the user terminal 50. The output unit 38 may notify the user of it using text, an image, a voice, or the like.

Next, the management device 40 will be described. The management device 40 manages an operation setting of the picking device 10, an operating state of the picking device 10, order information, an inventory state of the item 60, and the like.

As shown in FIG. 2, the management device 40 includes an acquisition unit 42, a storage unit 44, a processing unit 46, and an output unit 48. Some of functional constituents of the management device 40 may be realized by other devices such as a control unit embedded in the picking device 10, the control device 30, and the user terminal 50.

The acquisition unit 42 receives an input operation from the user and an input signal from the control device 30 and acquires order information including a list of items 60 to be picked, operation history information including past operation records of the holding unit 100, and the like. The operation records can include operation control information used for a picking operation of the picking device 10, sensing information of the various sensors 22, 24, 126, and 146 regarding the picking operation, operation determination information by the operation determination unit 366, and the like. Note that the acquisition unit 42 may directly acquire sensing information from the first housing unit sensor 22, the second housing unit sensor 24, the pinching unit sensor 126, and the adsorption unit sensor 146.

The storage unit 44 is configured to include a memory and a storage, and stores any information. For example, the storage unit 44 stores an operation history database (DB) 440, an item database (DB) 442, a robot database (DB) 444, an operation setting database (DB) 446, and a program 448 for causing a processor of the management device 40 to execute a predetermined command. The information stored by the storage unit 44 is not limited to these, and the storage unit 44 can store order information on the item 60 to be picked, a picking list for each type of the item 60 generated from the order information, information on the first housing unit C1 and the second housing unit C2, various types of data acquired from various sensors, results of arithmetic calculation processing by the processing unit 46, and the like.

Note that one or more of an operation history DB 440, an item DB 442, a robot DB 444, and an operation setting DB 446 may be stored in an external storage device, a cloud server, or the like that is connected to the management device 40 by wire or wirelessly. Alternatively, one or more of these may be stored in a storage unit of another information processing device, such as the control device embedded in the picking device 10, the control device 30, or the user terminal 50.

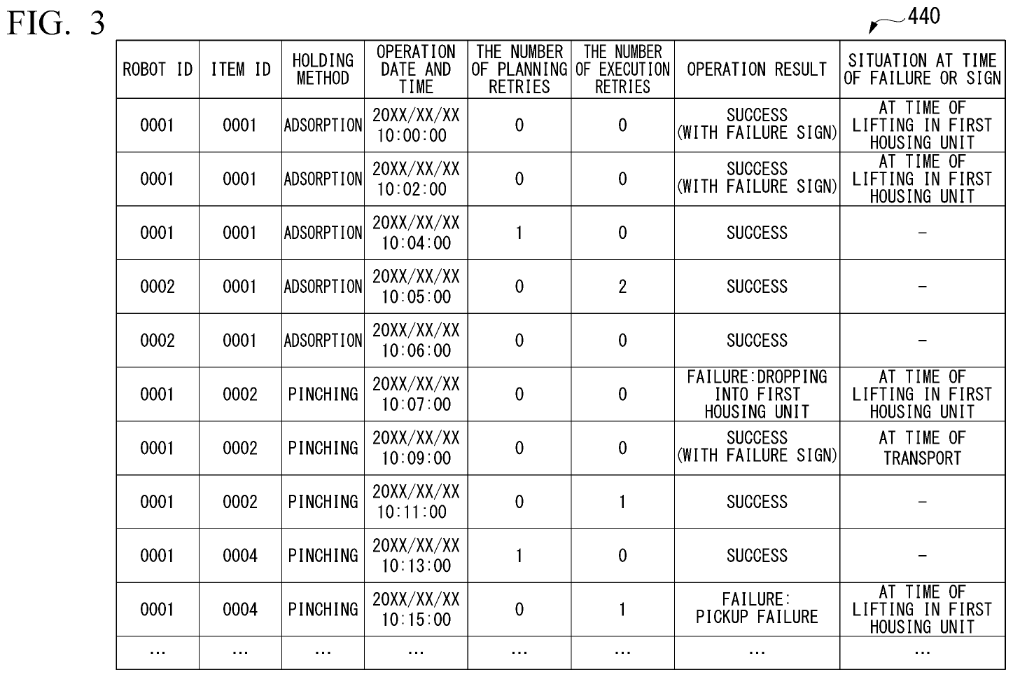

FIG. 3 is a diagram which shows a data structure of the operation history DB 440 according to the first embodiment.

As shown in FIG. 3, the operation history DB 440 holds operation history information such as setting parameters used in the picking operation and the success or failure of the operation. In the example shown in FIG. 3, operation records for each picking operation performed by the picking device 10 are described in each line of the operation history DB 440. Here, “operation records” in the operation history DB 440 refer to individual records described in each line of the operation history DB 440 in FIG. 3. “Operation history” refers to a set of “operation records.”

In the example shown in FIG. 3, the operation history DB 440 includes columns of “robot ID,” “item ID,” “holding method,” “operation date and time,” “the number of planning retries,” “the number of execution retries,” “operation result,” and “situation at the time of failure or sign.” The “robot ID” column describes an identification number of a robot (that is, the picking device 10) that has executed the picking operation. The “item ID” column describes an identification number of an item 60, which is a target of the picking operation. The “holding method” column describes a method by which the picking device 10 has held the item 60 in the picking operation. In this example, “pinching” or “adsorption” is described as the holding method. The “operation date and time” column describes a date and time in a case in which the picking device 10 has executed the picking operation. The “number of planning retries” column describes the number of times the planning unit 362 has retried generating a picking plan to perform a corresponding picking operation. The “number of execution retries” column describes the number of times the operation control unit 364 has retried the operation control of the picking device 10 to perform a corresponding picking operation. The “operation result” column describes an operation result of a corresponding picking operation determined by the operation determination unit 366. Specifically, it describes whether the picking operation has succeeded, whether there have been any signs of failure, in what situation the picking operation has failed, where the item 60 has dropped, and the like. In the “situation at the time of failure or sign” column, situations in which the operation result is determined to be “failure” or “there is a failure sign” are described.

For example, an operation record in which a picking device 10 corresponding to a robot ID: 0001 has held an item 60 corresponding to an item ID: 0001 by adsorption is described in a first line in FIG. 3. As a result of this picking operation, it is described that, although the picking operation has succeeded without a retry in either a planning stage or an execution stage, a sign of failure has been observed in a case in which the picking device 10 has lifted the item 60 in the first housing unit C1. An operation record in which the picking device 10 corresponding to the robot ID: 0001 has held an item 60 corresponding to an item ID: 0002 by pinching is described in a sixth line of FIG. 3. As a result of this picking operation, it is described that the picking operation fails without a retry in either the planning stage or the execution stage, and the item 60 has dropped into the first housing unit C1 in a case in which the picking device 10 has lifted the item 60 from the first housing unit C1. An operation record in which the picking device 10 corresponding to the robot ID: 0001 has held an item 60 corresponding to an item ID: 0004 by pinching is described in the eighth line in FIG. 3. As a result of this picking operation, an operation record in which the picking operation has succeeded after one retry in the operation execution stage is described. In this manner, the operation history DB 440 stores operation records of past picking operations as operation history information. Items in the operation history DB 440 are not limited to these, and any item related to a picking operation may be added thereto.

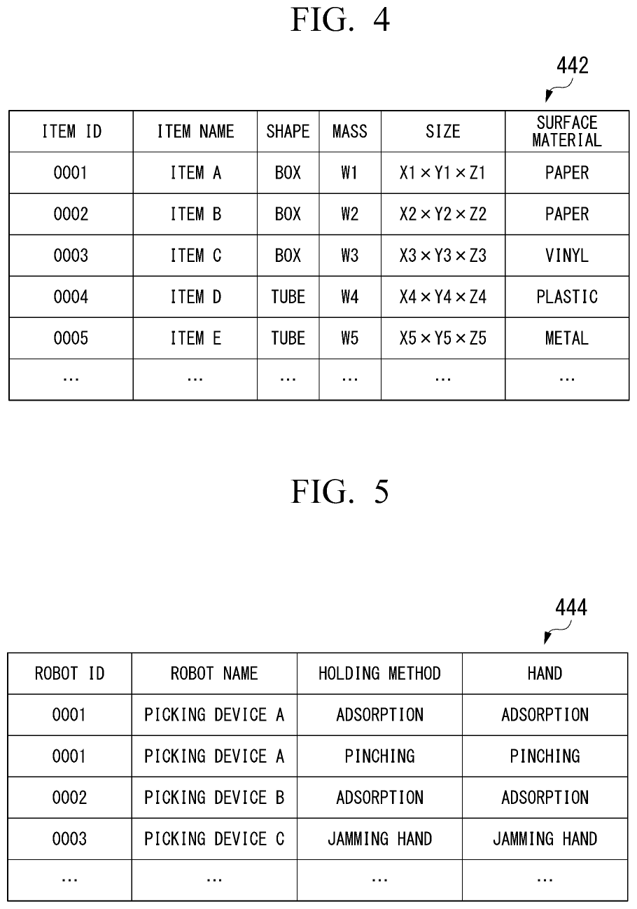

FIG. 4 is a diagram which shows a data structure of the item DB 442 according to the first embodiment.

As shown in FIG. 4, the item DB 442 holds information on one or more types of the item 60 to be held. In the example shown in FIG. 4, the item DB 442 includes columns of “item ID,” “item name,” “shape,” “mass,” “size,” and “surface material.” An identification number for each item 60 is described in the “item ID” column. A name for identifying the item 60 is described in the “item name” column. A shape of the item 60 is described in the “shape” column. A mass of the item 60 is described in the “mass” column. A size of the item 60 is described in the “size” column. A surface material of the item 60 is described in the “surface material” column. Items in the item DB 442 are not limited to these, but any items such as an appearance of a surface of the item 60 (opaque, transparent, reflective, and the like), flexibility, mobility of the center of gravity, air permeability, surface friction force, vibration resistance, and the like may be added thereto. Relationships between items 60, such as similarity between a plurality of items 60, may also be identified.

FIG. 5 is a diagram which shows a data structure of the robot DB 444 according to the first embodiment.

As shown in FIG. 5, the robot DB 444 holds information on one or more controllable robots. For example, the robot DB 444 holds information on an available picking device 10. In the example shown in FIG. 5, the robot DB 444 includes columns of “robot ID,” “robot name,” “holding method,” and “hand.” An identification number for each robot is described in the “robot ID” column. A name for identifying the picking device 10 is described in the “robot name” column. A holding method that can be executed by the picking device 10 is described in the “holding method” column. A type of hand of the picking device 10 that corresponds to a corresponding holding method is described in the “hand” column. Items in the robot DB 444 are not limited to these, and any item related to robots may be added thereto. Examples of other items include the number of fingers of the pinching hand 124, a size of the fingers, an arrangement of the fingers, a limit opening width of the pinching hand 124, the number of adsorption pads 156, a size of the adsorption pad 156, an arrangement pattern of the adsorption pads 156, types and materials of an item that the hand is good at gripping, a load capacity, materials of items that the hand is prohibited from gripping, and the like. Relationships between robots, such as similarity between a plurality of robots, may be identified.

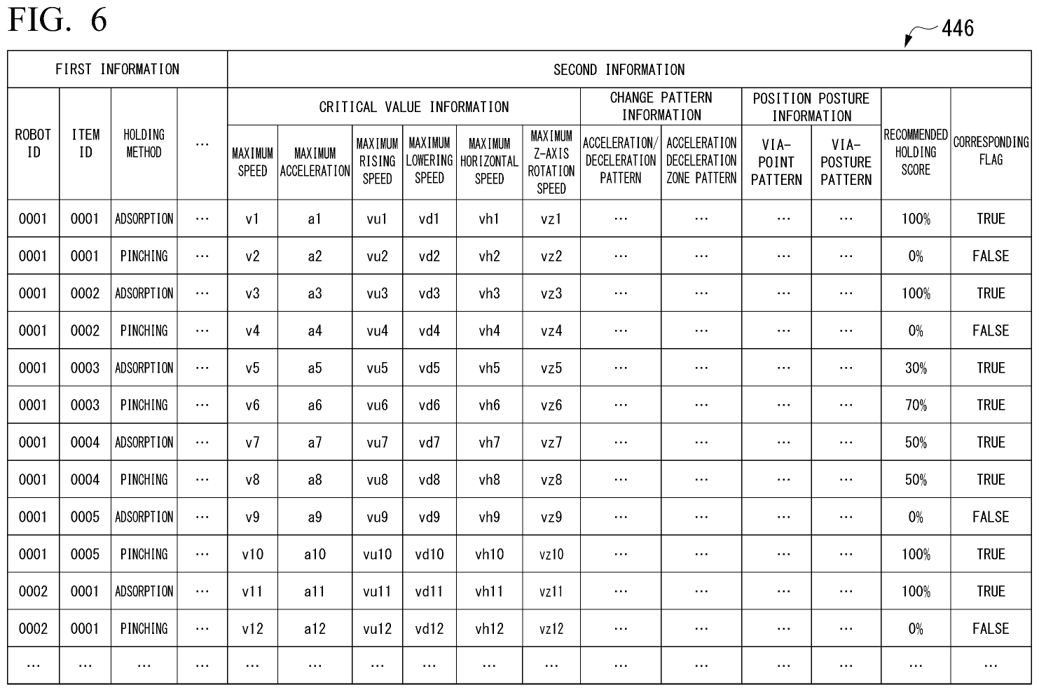

FIG. 6 is a diagram which shows a data structure of the operation setting DB 446 according to the first embodiment.

As shown in FIG. 6, the operation setting DB 446 holds information such as setting parameters necessary for a picking operation. In the example shown in FIG. 6, the operation setting DB 446 includes columns of “robot ID,” “item ID,” and “holding method” as “first information,” and columns of “maximum speed,” “maximum acceleration,” “maximum rising speed,” “maximum processing speed,” “maximum horizontal speed,” “maximum z-axis rotation speed,” “acceleration/deceleration pattern,” “acceleration/deceleration zone pattern,” “via-point pattern,” and “via-posture pattern,” and columns of “recommended holding score,” and “corresponding flag” as “second information.”

The first information is information entailed in a holding operation in which the holding unit 100 holds the item 60. Here, “entailed in a holding operation” refers to necessary information attached to a holding operation in a case in which the holding operation is executed, such as a robot ID of a robot that performs the holding operation, an item ID of an item that is a target of the holding operation, and a holding method used for the holding operation (for example, whether to use one of pinching, adsorption, and other holding methods, which griping unit or adsorption unit to use in a case in which there are a plurality of pinching units or adsorption units). The first information includes, for example, situation information that defines a situation in which the holding unit 100 holds the item 60. Specifically, the first information is information on a holding operation, that is, a picking operation, and includes information necessary to determine control content of a corresponding operation (for example, information on the holding unit 100 that performs the operation, information on the item 60 that is a target object of the operation, information on a holding method corresponding to the holding unit 100, and the like). In FIG. 6, an identification number of a robot that executes the picking operation is described in the “robot ID” column. An identification number of an item 60 to be picked is described in the “item ID” column. A holding method executed by the picking device 10 in the picking operation is described in the “holding method” column. Information on “a robot that performs the picking operation,” “an item 60 to be picked,” and “a holding method used” represents a situation or scene in which the picking operation is performed. Note that the first information is not limited to the example described above. For example, any information entailed in the example of the first information described above, such as how to place an item 60 (horizontal arrangement, vertical arrangement, diagonal arrangement, messy arrangement, and the like), may also be added.

The second information includes an operation setting for operating the holding unit. The operation setting includes setting information of various operation parameters that determine control content of a picking operation, corresponding to a holding operation identified by the first information. Specifically, the operation setting includes operation parameters for defining condition settings for the operation control of the holding unit 100 in each situation (for example, physical conditions such as a speed, acceleration, a route, a timing, force, pressure, or a voltage in various operations such as a moving operation, a picking operation, a holding operation, and a release operation of the holding unit 100). The operation setting may further include information on evaluation parameters such as a recommended level and a success rate of the picking operation defined by the operation parameters described above. In FIG. 6, an upper limit of the moving speed of the holding unit 100 in the picking operation is described in the “maximum speed” column. An upper limit of the acceleration of the holding unit 100 in the picking operation is described in the “maximum acceleration” column. An upper limit of the moving speed of a rising movement of the holding unit 100 in the picking operation is described in the “maximum rising speed” column. An upper limit of the moving speed of a lowering movement of the holding unit 100 in the picking operation is described in the “maximum lowering speed” column. An upper limit of the moving speed of a horizontal movement of the holding unit 100 in the picking operation is described in the “maximum horizontal speed” column. An upper limit of the moving speed of a rotational movement around the vertical axis (z-axis) of the holding unit 100 in the picking operation is described in the “maximum z-axis rotation speed” column. A speed change pattern (for example, trapezoidal acceleration, S-curve acceleration, or the like) in a case in which the holding unit 100 accelerates or decelerates in the picking operation is described in the “acceleration/deceleration pattern” column. Speed and acceleration patterns of the holding unit 100 for each zone that constitutes the movement route of the holding unit 100 in the picking operation are described in the “acceleration/deceleration zone pattern” column. A via-point pattern that defines the movement route of the holding unit 100 in the picking operation is described in the “via-point pattern” column. A posture pattern of the holding unit 100 on the movement route in the picking operation is described in the “via-posture pattern” column. A recommended score for the holding method in a case in which the same robot holds the same item is described in the “recommended holding score” column. For example, referring to the first and second lines of FIG. 6, as a holding method for the robot with a robot ID: 0001 to hold an item 60 with an item ID: 0001, a holding recommendation score of “adsorption” is 100%, whereas the holding recommendation score for “pinching” is 0%. Therefore, “adsorption” is 100% recommended as the holding method for this picking operation. In the “corresponding flag” column, the usability of the operation setting based on the recommended holding score is described as TRUE or FALSE. In the first line of FIG. 6, a correspondence flag is described as “TRUE” in response to the recommended holding score being 100%. This indicates that the operation setting in the first line can be used for the picking operation. In the second line of FIG. 6, the correspondence flag is described as “FALSE” in response to the recommended holding score being 0%. This indicates that the operation setting in the first line need not be used for the picking operation.

A method of describing each item is not particularly limited. For example, values such as the “maximum rising speed,” “maximum lowering speed,” and “maximum horizontal speed” may be expressed as an absolute value of speed, may be expressed as a coefficient value by which a “maximum speed” such as “70%” is multiplied or may be expressed in any other format. Similarly, values such as “maximum speed” and “maximum acceleration” may also be expressed as absolute values, may be expressed as coefficient values by which the upper limit speed determined for the picking device 10 is multiplied, or may be expressed in any other format.

“Maximum speed,” “maximum acceleration,” “maximum rising speed”, “maximum processing speed,” “maximum horizontal speed,” and “maximum z-axis rotation speed” indicate critical values of physical parameters of the holding unit 100 in the picking operation and are collectively referred to as “critical value information.” The “acceleration/deceleration pattern” and the “acceleration/deceleration zone pattern” indicate a change pattern of the physical parameters of the holding unit 100 in the picking operation, and are collectively referred to as “change pattern information.” The “via-point pattern” and the “via-posture pattern” indicate the position or posture of the holding unit 100 in the picking operation, and are collectively referred to as “position posture information.”

In this manner, in the operation setting DB 446, the first information and the second information are recorded in association with each other. Specifically, different first information and second information corresponding to corresponding first information are described in each line of the operation setting DB 446. For example, the management device 40 uses first information of a next picking operation as a key and outputs corresponding second information to the control device 30. The control device 30 can use the operation setting included in the received second information as a default value in the next picking operation. As described above, as an actual operation parameter, this default value may be used as it is, or a value obtained by the planning unit 362 or the like adjusting the default value may also be used as necessary. For example, the first information may include information identifying the holding operation in terms of hardware or physical configuration, and the second information may include information identifying the holding operation in terms of software or operational control.

The processing unit 46 performs predetermined arithmetic calculation processing on the input received by the acquisition unit 42. As shown in FIG. 2, the processing unit 46 includes a history update unit 460, an update determination unit 462, an update target determination unit 464, an operation setting update unit 466, and a display control unit 468 as its functional constituents.

The history update unit 460 updates the operation history DB 440 by recording the operation records acquired by the acquisition unit 42 in the operation history DB 440. Specifically, the history update unit 460 adds a new line to the operation history DB 440 and inputs each item on the basis of the acquired operation records. The history update unit 460 may update the operation history DB 440 every time a picking operation is performed, or may reflect these operation records collectively in the operation history DB 440 after the operation records of a plurality of the picking operations are acquired.

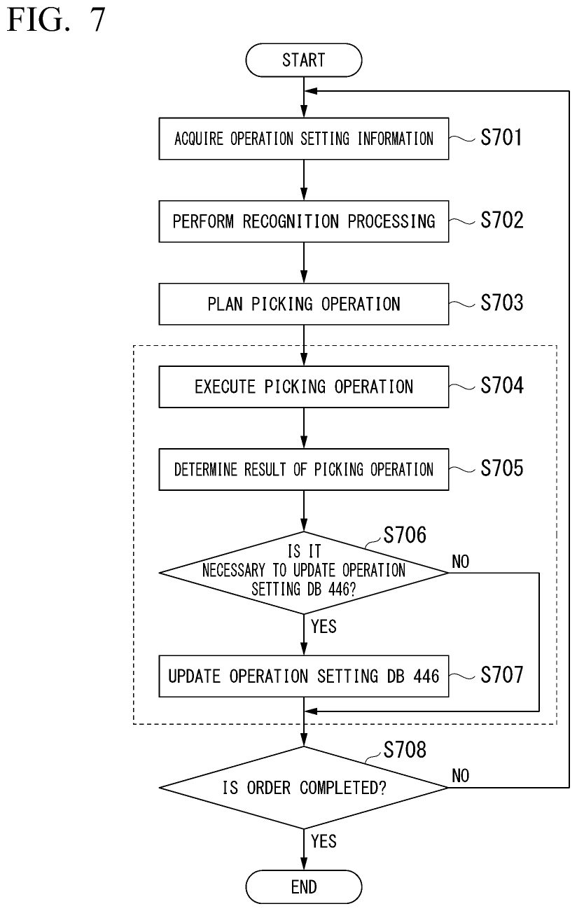

The update determination unit 462 determines whether to update the operation setting DB 446 on the basis of the operation history DB 440. For example, the update determination unit 462 determines whether to update the operation setting DB 446 on the basis of two or more operation records (for example, including the most recently added operation record) included in the updated operation history DB 440. By performing determination processing on the basis of a plurality of operation records, the update determination unit 462 can manage the operation setting on the basis of a trend of picking operations by the picking device 10, instead of immediately updating the operation setting DB 446. Specifically, the update determination unit 462 can determine that an operation setting in the operation setting DB 446 is not appropriate in a case in which many failures or signs of failure are seen in recent operation records in the operation history DB 440, and determine to update the operation setting DB 446. In a case in which the update determination unit 462 determines to update the operation setting DB 446, it also determines how to update the operation setting DB 446. A specific example of the determination processing will be described below with reference to FIGS. 7 to 9.

The update target determination unit 464 determines an update target in the operation setting DB 446 in a case in which the update determination unit 462 has determined to update the operation setting DB 446. That is, in a case in which the update determination unit 462 has determined to update the operation setting DB 446 for particular first information, the update target determination unit 464 determines whether to update the operation setting DB 446 for other first information different from the particular first information. For example, a case where the update determination unit 462 determines to update a first line of the operation setting DB 446 in FIG. 6 will be considered. For example, the update determination unit 462 can determine to update second to tenth lines that have the same robot ID in the same manner as the first line. Alternatively, the update determination unit 462 may determine to update third, fifth, seventh, and ninth lines that have the same robot ID and holding method in the same manner as the first line. Alternatively, the update target determination unit 464 may determine to update an eleventh line that has the same item ID and holding method in the same manner as the first line.

A reference by which the update target determination unit 464 determines the update target is not particularly limited, but, for example, attributes and/or an arrangement of the item 60, attributes and/or an arrangement of the holding unit 100, or the like can be used as the reference. More specifically, for example, one or more of the following references can be used. The update target determination unit 464 can extract first information that has any of the following items or a particular combination in common or in a similar range with respect to the first information determined to be updated by the update determination unit 462, and determine second information corresponding to the extracted first information as the update target.
(1) Types of robot
(2) Types of item 60
(3) Mass of item 60
(4) Types of surface material of item 60
(5) How to place item 60
(6) Types of holding method (adsorption, pinching, and the like)

In a case in which a relationship between the items 60 (such as similarity between the items 60) is identified in the item DB 442, the update target determination unit 464 can determine the update target by referring to that information. In a case in which the item 60 has dropped from the holding unit 100, the update target determination unit 464 may determine that all items 60 having a mass greater than or equal to a mass of the dropped item 60 are update targets.

Note that items other than the first line do not necessarily have to be updated in exactly the same manner as the first line. The update target determination unit 464 can determine how to update each line determined to be an update target.

The operation setting update unit 466 updates the operation setting DB 446 for the items determined to be updated by the update determination unit 462 and the items determined to be update targets by the update target determination unit 464.

The display control unit 468 generates display control information for presenting results of the arithmetic calculations by the processing unit 46 to the user. The display control information is used to, for example, display visual information on the user terminal 50. Note that devices other than the user terminal 50 (the picking device 10, control device 30, management device 40, and the like) may display visual information on the basis of this display control information. For example, the display control unit 368 generates, on the basis of the update determination information acquired from update determination unit 462, update target determination information acquired from update target determination unit 464, operation history information acquired from operation history DB 440, and operation setting information acquired from the operation setting DB 446, and the like, display control information for outputting a visual display where these types of information are reflected.

The output unit 48 is configured to include an input or output interface, and outputs information stored in the storage unit 44, results of arithmetic calculation processing in the processing unit 46, and the like. For example, the output unit 48 transmits the operation setting of the operation setting DB 446 updated by the operation setting update unit 466 to the control device 30. For example, the output unit 48 outputs display control information received from the display control unit 468 to the user terminal 50. The output unit 48 may notify the user of it using text, an image, a voice, or the like.

Next, the user terminal 50 will be described. The user terminal 50 is an information processing device for the user to manage and control the picking device 10, the control device 30, the management device 40, and the like. The user terminal 50 may be a general computer (for example, a personal computer), a mobile apparatus such as a smartphone or a tablet, or a display device that presents a visual display to the user.

As shown in FIG. 2, the user terminal 50 includes an acquisition unit 52, a storage unit 54, a processing unit 56, and an output unit 58. The output unit 58 includes a display unit 580 for displaying visual information. Some of the functional constituents of the user terminal 50 may be realized by other devices such as a control unit embedded in the picking device 10, the control device 30, and the management device 40.

The acquisition unit 52 receives an input operation from the user, an input signal from the control device 30 and the management device 40, and the like. For example, the acquisition unit 52 can acquire order information, update determination information or operation setting update information of the operation setting DB 446, or the like as an input from the user. For example, the acquisition unit 52 may acquire display control information from the control device 30 and/or the management device 40 for generating a visual display to present to the user.

The storage unit 54 is configured to include a memory and a storage, and stores any information. For example, the storage unit 54 stores a program that causes the processor of the user terminal 50 to execute a predetermined command, and the like.

The processing unit 56 performs predetermined arithmetic calculation processing on the input received by the acquisition unit 52. For example, the processing unit 56 includes a display control unit 560 that controls the display unit 580 such that it displays visual information based on display control information acquired by the acquisition unit 52.

The output unit 58 is configured to include an input or output interface, and outputs information acquired by the acquisition unit 52, results of arithmetic calculation processing in the processing unit 56, and the like. For example, the output unit 58 can output input information from the user to the control device 30 or the management device 40. Moreover, the output unit 58 can notify the user of it using text, an image, a voice, and the like. For example, the output unit 58 can cause the display unit 580 to display a management and control screen as shown in FIG. 10 to the user on the basis of the display control information received from the control device 30 and the management device 40. A screen example will be described below with reference to FIG. 10.

Next, a flow of processing by the picking system 1 will be described with reference to FIGS. 7 to 9.

FIG. 7 is a flowchart which shows an overall flow of a picking operation by the picking system 1 according to the first embodiment.

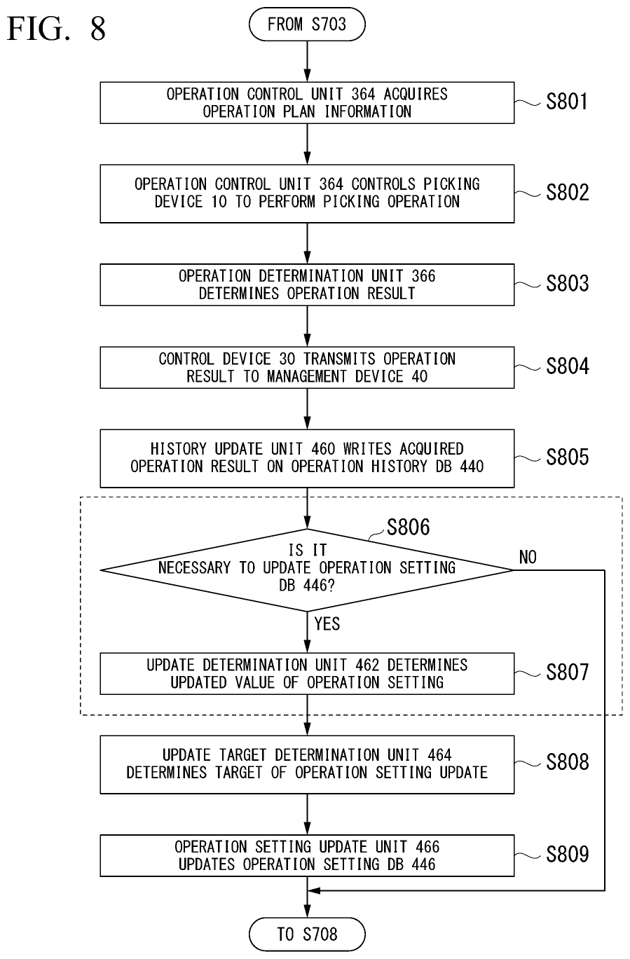

FIG. 8 is a flowchart which shows processing in which the operation setting update unit 466 according to the first embodiment updates the operation setting DB 446.

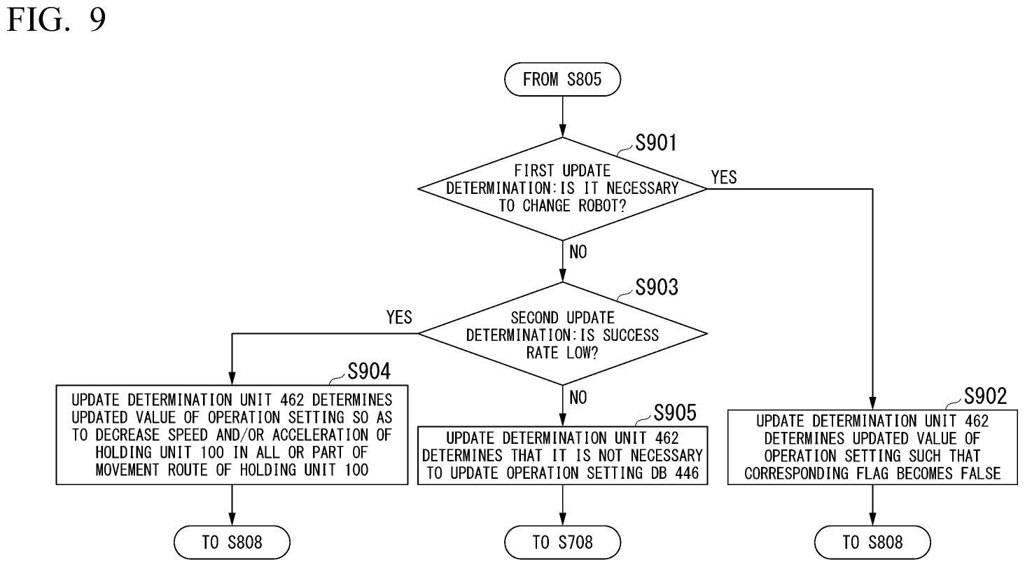

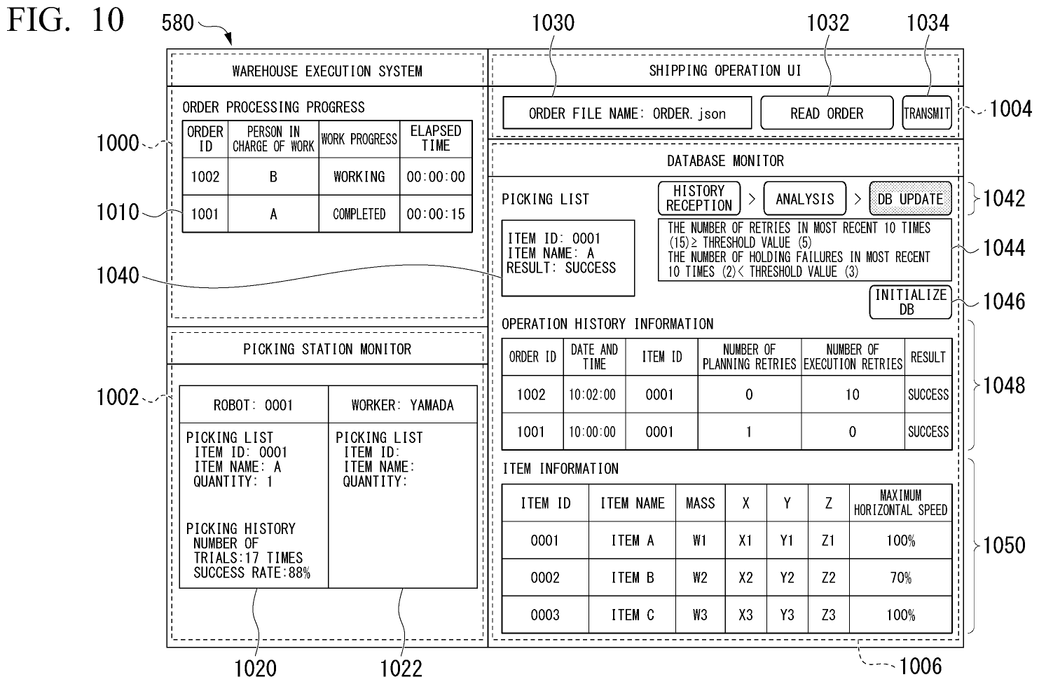

FIG. 9 is a flowchart which shows processing in which the update target determination unit 464 according to the first embodiment determines an update target.

First, with reference to FIG. 7, an overall flow from in a case in which the picking system 1 receives an order to in a case in which the order is completed will be described. In step S701, the acquisition unit 32 acquires operation setting information for a picking operation from the management device 40. In step S702, the recognition unit 360 performs recognition processing on the basis of sensing information. In step S703, the planning unit 362 generates a plan for a picking operation on the basis of the operation setting information and the recognition information acquired from the recognition unit 360. In step S704, the operation control unit 364 controls the operation of the holding unit 100 such that it executes the picking operation on the basis of the picking plan generated by the planning unit 362. In step S705, the operation determination unit 366 determines a result of the picking operation of the holding unit 100. The output unit 38 transmits a condition setting of the picking operation and a result of the operation determination by the operation determination unit 366 to the management device 40 as operation records. In step S706, the update determination unit 462 refers to the operation history DB 440 and determines whether it is necessary to update the operation setting DB 446. In a case in which the update determination unit 462 determines that it is necessary to update the operation setting DB 446 (YES in step S706), the operation setting update unit 466 updates the operation setting DB 446 in step S707. On the other hand, in a case in which the update determination unit 462 determines that it is not necessary to update the operation setting DB 446 (NO in step S706), the operation setting update unit 466 does not update the operation setting DB 446. Next, in step S708, the management device 40 determines whether the order is completed. In a case in which it is determined that the order is not completed (NO in step S708), a flow returns to step S701 and the picking operation is executed again. On the other hand, in a case in which it is determined that the order is completed (YES in step S708), order processing ends.

FIG. 8 shows processing of steps S704 to S707 of FIG. 7 in detail.

After the planning unit 362 generates a picking plan in step S703, the operation control unit 364 acquires operation plan information including the picking plan from the planning unit 362 in step S801. In step S802, the operation control unit 364 controls the picking device 10 to perform the picking operation according to the picking plan. In step S803, the operation determination unit 366 determines a result of the picking operation. In step S804, the output unit 38 of the control device 30 transmits operation records including operation determination information to the management device 40. In step S805, the history update unit 460 writes the operation records acquired from the control device 30 to the operation history DB 440, and updates the operation history DB 440. In step S806, the update determination unit 462 determines whether it is necessary to update the operation setting DB 446 on the basis of the updated operation history information of the operation history DB 440. In a case in which the update determination unit 462 determines to update the operation setting DB 446 (Yes in step S806), the update determination unit 462 determines an updated value of the operation setting of the update target in step S807. In step S808, the update target determination unit 464 determines whether there is a target other than the update target described above whose operation setting needs to be updated in the operation setting DB 446. In step S809, the operation setting update unit 466 updates the operation setting DB 446 on the basis of results of the determination by the update determination unit 462 and the update target determination unit 464. Thereafter, the flow proceeds to step S708 of FIG. 7 (order completion determination).

On the other hand, in a case in which the update determination unit 462 determines not to update the operation setting DB 446 (NO in step S806), the flow skips steps S807 to S809 and proceeds to step S708 of FIG. 7 (order completion determination). That is, the operation setting DB 446 is not updated, and the previous operation setting is used even in a next picking operation.

FIG. 9 shows the processing of steps S806 and S807 in FIG. 8 in more detail.

After the operation history DB 440 is updated in step S805, the update determination unit 462 performs a first update determination in step S901. In the first update determination, for example, the update determination unit 462 determines whether it is necessary to update the robot or the holding unit 100 to execute the next picking operation on the basis of the operation history DB 440. For example, the update determination unit 462 uses the first information S1 on the next picking operation as a key to search for past operation records whose first information is S1 from the operation history DB 440. The update determination unit 462 can calculate the number of occurrences or a frequency of occurrence of a failure or a similar result in these operation records that share the first information S1, and use a result of the calculation as a basis for determination. For example, the update determination unit 462 can calculate, as a failure index, the number or frequency of operation records with a failure result among the most recent predetermined number of operation records whose first information is S1. Moreover, the update determination unit 462 can calculate, as an execution retry index, the number or frequency of operation records for which picking operation control has been retried among the most recent predetermined number of operation records whose first information is S1.

The update determination unit 462 can determine that the robot or holding unit 100 needs to be changed (YES in step S901) to perform the next picking operation in a case in which the failure index is equal to or greater than a predetermined threshold value and/or in a case in which the execution retry index is equal to or greater than a predetermined threshold value. In this case, in step S902, the update determination unit 462 determines the updated value of the operation setting such that a corresponding flag of the currently selected robot or holding unit 100 becomes “FALSE.” For example, the update determination unit 462 can change the corresponding flag of the currently selected robot or holding unit 100 from “TRUE” to “FALSE” in a case in which the item drops a times or more among the most recent b time operation records for each of the item 60 dropping into the first housing unit C1, dropping into the second housing unit C2, and dropping outside the housing units C1 and C2. As a result, it is expected to improve reliability of the picking operation by making the current robot or holding unit 100 unusable and replacing it with another one in a case in which many failures or retries occur. The flow then proceeds to step S808 of FIG. 8.

On the other hand, in a case in which the failure index and execution retry index are less than the threshold value, the update determination unit 462 can determine that it is not necessary to change the robot or the holding unit 100 to execute a next picking operation (NO in step S901). In this case, in step S903, the update determination unit 462 performs a second update determination. In the second update determination, for example, the update determination unit 462 determines whether a success rate of the next picking operation is low. For example, similarly to the first update determination, the update determination unit 462 uses the first information S1 on the next picking operation as a key to search for past operation records whose first information is S1 from the operation history DB 440. The update determination unit 462 can calculate the number of occurrences or the frequency of occurrence of a failure sign or a similar result in these operation records that share the first information S1, and use a result of the calculation as a basis for determination. For example, the update determination unit 462 can calculate, as a failure sign index, the number or frequency of operation records in which a picking operation has succeeded but a failure sign has been detected among the most recent predetermined number of operation records whose first information is S1. In addition, the update determination unit 462 uses the number or frequency of operation records for which picking plan generation has been retried as a planning retry index, and uses the number or frequency of operation records for which picking operation control has been retried as an execution retry index, respectively, among the most recent predetermined number of operation records whose first information is S1.

The update determination unit 462 can determine that the success rate of a next picking operation is low (YES in step S903) in a case in which the failure index is equal to or greater than a predetermined threshold value, in a case in which the failure sign index is equal to or greater than a predetermined threshold value, in a case in which the planning retry index is equal to or greater than a predetermined threshold value, and/or in a case in which the execution retry index is equal to or greater than a predetermined threshold value. In this case, in step S904, the update determination unit 462 determines the updated value of the operation setting so as to decrease the speed and/or acceleration of the holding unit 100 over an entire or a part of the movement route of the holding unit 100. For example, the update determination unit 462 determines the updated value of the operation setting so as to decrease a maximum value of the speed and/or acceleration described in the operation setting DB 446. As a result, it is expected to improve the reliability of the picking operation by slowing down the operation of the holding unit 100 in a case in which many failures, failure signs, or retries occur. Thereafter, the flow proceeds to step S808 of FIG. 8.

Here, specific processing content of step S904 will be further described using an example.

For example, the update determination unit 462 can decrease the maximum speed by, for example, 10% in a case in which the item drops a times or more among the most recent b time operation records for each of the item 60 dropping into the first housing unit C1, dropping into the second housing unit C2, or dropping outside the housing units C1 and C2. Alternatively, in a case in which a probability of dropping outside the housing units C1 and C2 is equal to or greater than a predetermined threshold value, the maximum speed can be decreased by, for example, 10%.

In a case in which the holding method is pinching, the operation determination unit 366 can determine whether an event in which a change in an opening amount of the pinching claw 134 is equal to or greater than a threshold value has occurred between two predetermined via-points P1 and P2 that constitute the movement route during the transport operation of the item 60, and transmit it to the management device 40 as operation records. The update determination unit 462 can determine that the holding state during the transport is unstable and decrease the maximum speed by, for example, several percent in a case in which the event described above has occurred c or more times among the most recent b time operation records.

In a case in which the holding method is adsorption, the operation determination unit 366 can determine whether an event in which a change in suction force detected by the adsorption unit sensor 146 between the two predetermined via-points P1 and P2 that constitute the movement route is equal to or greater than a threshold value has occurred during the transport operation of the item 60, and transmit a result to the management device 40 as operation records. In a case in which the update determination unit 462 determines that the event described above has occurred c times or more in the most recent b time operation records, it can determine that the holding state during the transport is unstable and decrease the maximum speed by, for example, several percent.

On the other hand, in a case in which the failure index, the failure sign index, the planning retry index, and the execution retry index are less than the predetermined threshold values, the update determination unit 462 determines that the success rate of a next picking operation is not low (NO in step S903). In this case, in step S905, the update determination unit 462 determines that it is not necessary to update the operation setting DB 446. The flow then proceeds to step S708 of FIG. 7.

In this manner, the update determination unit 462 determines whether it is necessary to update the operation setting DB 446 on the basis of the operation history information, which is a collection of past operation records. Various indexes can be used for an update determination. For example, the update determination unit 462 can perform an update determination on the basis of failure information on a failure of a picking operation, failure sign information on a failure sign of a picking operation, retry information on a retry of a picking operation, and the like.

Note that a method of updating the operation setting in the first update determination is not limited to the example described above. For example, the update determination unit 462 may decrease the recommended holding score of the currently selected operation setting by a predetermined amount or ratio in a case in which the failure index is equal to or greater than a predetermined threshold value and/or the execution retry index is equal to or greater than a predetermined threshold value. In this manner, by updating the operation setting DB 446 so as not to preferentially use operation setting with a low success rate, it is possible to increase the success rate of the picking operation. In addition, instead of or in addition to the example described above, the update determination unit 462 may determine that it is necessary to change the robot or holding unit 100 (Yes in step S901) to execute a next picking operation in a case in which the failure sign index is equal to or greater than a predetermined threshold value. For example, the update determination unit 462 may change the corresponding flag of the currently selected robot or holding unit 100 from “TRUE” to “FALSE,” or may decrease the recommended holding score of the currently selected operation setting by a predetermined amount or ratio in a case in which the holding state during the transport is determined to be unstable on the basis of a change in opening amount of the pinching claw 134 or a change in suction force detected by the adsorption unit sensor 146, as in the example described above.

Next, an example of the screen displayed on the display unit 580 will be described with reference to FIG. 10.

FIG. 10 is a diagram which shows an example of the screen displayed on the display unit 580 according to the first embodiment.

As shown in FIG. 10, the display control unit 560 controls the display unit 580 to display a warehouse execution system display unit 1000, a picking station monitor unit 1002, a shipping operation UI unit 1004, and a database monitor unit 1006 to the user.

The warehouse execution system display unit 1000 displays an order processing progress table 1010 indicating a progress state of an order. The order processing progress table 1010 shows, for example, a robot in charge, a progress, and an elapsed time for each order on the basis of the order processing progress information acquired from the management device 40.

The picking station monitor unit 1002 displays a robot monitor unit 1020 that shows an operating state of a robot in a work space, and a worker monitor unit 1022 that shows an operating state of a worker in the work space. The robot monitor unit 1020 displays, for example, information on a picking list that is being processed by a robot, history information on past picking operations, and the like on the basis of operation information of each robot acquired from the control device 30 or the management device 40. The worker monitor unit 1022 displays, for example, information on the picking list that is being processed by a worker, history information on past picking operations, and the like on the basis of operation information of each worker acquired from the control device 30 or the management device 40.

The shipping operation UI unit 1004 displays an order file name display unit 1030 that displays a file name including an order to be processed, an “order reading” button 1032, and a “transmission” button 1034. In response to the user operating the “order reading” button 1032, the shipping operation UI unit 1004 displays a screen that allows the user to select an order file to be processed. The order file name display unit 1030 displays a name of the selected order file in response to the user selecting the order file. In response to the user operating the “transmission” button 1034, the shipping operation UI unit 1004 instructs the processing unit 56 to transmit the selected order file to the management device 40 as a next processing target.

The database monitor unit 1006 displays a picking list display unit 1040 that shows a picking list to be processed, an update progress display unit 1042 that shows a progress of update processing of the operation setting DB 446, an update determination display unit 1044 that shows a result of the update determination by the update determination unit 462, a “DB initialization” button 1046 for initializing the operation setting DB 446, an operation history information table 1048 that shows operation history information based on the operation history DB 440, and an item information table 1050 that shows item information based on the item DB 442.

In the example of FIG. 10, the picking list display unit 1040 displays, for example, a result of a most recent picking operation in the picking list on the basis of the operation determination information acquired from the control device 30.

The update progress display unit 1042 divides and shows update processing of the operation setting DB 446 into three stages of the display unit, such as “history reception” (that is, the management device 40 receives operation records from the control device 30), “analysis” (that is, the update determination unit 462 determines whether to update the operation setting DB 446 and the update target determination unit 464 determines an update target), and “DB update” (that is, the operation setting update unit 466 updates the operation setting DB 446). The update progress display unit 1042 can indicate the progress of the update processing of the operation setting DB 446 by changing a color of the display unit.

The update determination display unit 1044 displays a result of the determination by the update determination unit 462 on whether to update the operation setting DB 446 on the basis of the operation history DB 440. In the example shown in FIG. 10, a first line of the update determination display unit 1044 displays that the number of retries in the most recent 10 times (15 times) is equal to or greater than a threshold value (5 times). The user can understand, based on this description, that the update determination unit 462 has determined to update the operation setting DB 446 because a condition that the number of retries is equal to or greater than the threshold value is satisfied. In addition, a second line of the update determination display unit 1044 displays that the number of holding failures (2) in the most recent 10 times is smaller than a threshold value (3). The user can understand, based on this description, that the update determination unit 462 has determined not to update the operation setting DB 446 because a condition that the number of failures is equal to or greater than the threshold value is not satisfied.

The database monitor unit 1006 instructs the processing unit 56 to cause the management device 40 to initialize the operation setting DB 446, for example, in response to the user operating the “DB initialization” button 1046.

The operation history information table 1048 displays operation history information including past operation records. An “order ID” column indicates an identification number of an order. A “date and time” column indicates a date and time in a case in which a picking operation has been executed. The “item ID” column indicates an identification number of an item 60 to be held. The “number of planning retries” column indicates the number of retries for generating a picking plan in a corresponding picking operation. The “Number of execution retries” column indicates the number of retries of operation control in a corresponding picking operation. A “result” column shows a result of the picking operation determined by the operation determination unit 366.

The item information table 1050 displays information on various items 60 held in the item DB 442. The “item ID” column shows the identification number of an item 60. The “mass” column shows the mass of the item 60. The “X,” “Y,” and “Z” columns indicate the size of the item 60. The “maximum horizontal speed” column indicates the upper limit value of the horizontal moving speed of the holding unit 100 set for each item 60. For example, the maximum horizontal speed of 70% means that the maximum horizontal speed of the item 60 is 0.7v1 in a case in which the maximum speed of the item 60 is set to v1 in the operation setting DB 446.

The display unit 580 displays a screen as shown in FIG. 10, thereby the user can ascertain an order progress, a picking list progress, a state of a work site, picking operation history, an update state of the operation setting DB 446, item information, and the like all at once. Such a user interface is particularly useful in that the user can specifically confirm the most recent operation history information and content of a result of the update determination of the operation setting DB 446 based on the operation history information. The user can also execute transmission of a new order, initialization of the operation setting DB 446, and the like from the screen shown in FIG. 10.

According to the configuration described above, the picking system 1 can improve an efficiency of a picking operation by determining whether to update the operation setting information on the basis of the operation history of a holding unit. In particular, by performing an update determination of operation setting information on the basis of a plurality of operation records, the update determination unit 462 can determine whether to update the operation setting information on the basis of a tendency of operation control, instead of changing a setting for each individual operation each time. As a result, the picking system 1 can improve the efficiency of a picking operation.

In a conventional picking system, it may not be a sufficient response to apply only basic operation settings for adjustments according to the characteristics of various items 60 and individual robots, and responses to changes in characteristics due to an elapse of time such as aging. According to the configuration described above, the picking system 1 can appropriately adjust the operation setting such as the moving speed of the holding unit 100 according to the robot and the item 60 by repeating a picking operation.

According to one embodiment, in a case in which the update determination unit 462 has determined to update the operation setting DB 446 for particular first information, it determines whether to update the operation setting DB 446 for other first information. According to such a configuration, in a case in which the update determination unit 462 has determined to update a particular item of the operation setting DB 446, the picking system 1 collectively updates similar other items, and thereby the picking system 1 can improve the efficiency of the operation setting update processing. Moreover, the picking system 1 can manage the operation setting DB 446 in a unified manner.

According to one embodiment, the update determination unit 462 determines whether to update the operation setting DB 446 regarding the other first information at least on the basis of one or more of the attributes of the item 60, the arrangement of the item 60, the attributes of the holding unit 100, and the arrangement of the holding unit 100 in the particular first information and the other first information. According to such a configuration, by using the attributes and arrangement of the item 60 and the holding unit 100 as references for determining an update target, the operation setting update unit 466 can collectively update second information on a plurality of pieces of similar first information.

According to one embodiment, the operation determination unit 366 evaluates a result of the operation control of the holding unit 100. The operation history DB 440 includes information of evaluation of past operation control. According to such a configuration, the operation setting update unit 466 can update the operation setting DB 446 on the basis of the result of past operation control such that a result of subsequent operation control is improved.

According to one embodiment, the operation determination unit 366 determines whether there has been a sign of failure in the operation control of the holding unit 100. The information of evaluation on past operation control included in the operation history DB 440 includes information indicating whether there has been a sign of failure. According to such a configuration, by using a failure sign as a reference for an update determination, the operation setting update unit 466 can update the second information before the holding unit 100 actually fails in picking. As a result, the picking system 1 can reduce a possibility that picking will fail.

According to one embodiment, the update determination unit 462 determines whether to update the operation setting DB 446 at least on the basis of the number of occurrences or a frequency of occurrence of a particular evaluation in the operation history DB 440. According to such a configuration, instead of immediately responding to an operation failure, the picking system 1 updates the operation setting DB 446 on the basis of the number or frequency of particular evaluations (such as failures) over a certain period of time, and thereby it is possible to perform an overall optimization based on mid- to long-term evaluation of the operation control.

According to one embodiment, the update determination unit 462 performs a first update determination of determining whether to update the operation setting DB 446 to change the holding unit 100 that performs a picking operation. According to such a configuration, in a case in which a current holding unit is not suitable for a picking operation due to occurrence of frequent failures, the picking system 1 can increase a probability of success of the picking operation by using a more suitable picking device 10 or holding device.

According to one embodiment, the update determination unit 462 performs a second update determination of determining whether to update the operation setting DB 446 to decrease the speed and/or acceleration of the holding unit 100 in all or a part of the movement route of the holding unit 100. According to such a configuration, in a case in which there are many retries or warnings, the picking system 1 can increase the probability of success of the picking operation by slowing down the operation of the holding unit 100.

According to one embodiment, the operation history DB 440 includes retry information indicating whether the processing unit 36 of the control device 30 has retried processing for a picking operation. The update determination unit 462 determines whether to update the operation setting DB 446 at least on the basis of the retry information. According to such a configuration, by using the retry information as a reference for an update determination, the update determination unit 462 can perform an update determination using a smaller number of operation histories than in a case in which an update determination is performed on the basis of simply a result of a picking operation (success or failure).

According to one embodiment, the update determination unit 462 determines to update the operation setting DB 446 in a case in which the number or frequency of retries is equal to or greater than a threshold value. According to such a configuration, in a case in which there are many retries, the operation control of the holding unit 100 may be inappropriate. Accordingly, the update determination unit 462 can increase the probability of success of a picking operation by updating the operation setting DB 446.

According to one embodiment, the operation setting DB 446 includes critical value information that specifies an upper limit value and/or a lower limit value of a physical quantity related to the operation control of the holding unit 100. The operation setting update unit 466 updates the critical value information in a case in which it is determined to update the operation setting DB 446. According to such a configuration, the operation setting update unit 466 can increase the probability of success of a picking operation by adjusting a critical value of the physical quantity according to the operation history information.

According to one embodiment, the operation setting DB 446 includes change pattern information that specifies a change pattern of a physical quantity related to the operation control of the holding unit 100. The operation setting update unit 466 updates the change pattern information in a case in which it is determined to update the operation setting DB 446. According to such a configuration, the operation setting update unit 466 can increase the probability of success of a picking operation by changing the change pattern of the physical quantity according to the operation history information (for example, setting a change in physical quantity to be gradual or rapid).

According to one embodiment, the operation setting DB 446 includes position posture information that specifies the position and/or posture of the holding unit 100. The operation setting update unit 466 updates the position posture information in a case in which it is determined to update the operation setting DB 446. According to such a configuration, the operation setting update unit 466 can increase the probability of success of a picking operation by adjusting the position and posture of the holding unit 100 for holding the item 60 according to the operation history information.

According to one embodiment, the operation setting in the operation setting DB 446 is a default setting in the operation control of the holding unit 100. According to such a configuration, the picking system 1 can update a basic operation setting, which the operation control unit 364 uses as a default value in a case in which controlling the operation of the holding unit 100, on the basis of the operation history.

According to one embodiment, the display control units 368, 468, and 560 cause the display unit 580 to display a first visual element 1048 related to the operation history DB 440 including the operation records of the holding unit 100 and a second visual element 1044 related to the operation setting DB 446 in which first information entailed in a holding operation in which the holding unit 100 holds the item 60 is associated with second information that includes an operation setting for operating the holding unit 100. The acquisition units 32, 42, and 52 acquire the operation records of the holding unit 100. In response to the acquisition of the operation records, the display control units 368, 468, and 560 cause the first visual element 1048 to display the operation history DB 440 to which the acquired operation records are added. In response to the addition of the acquired operation records to the operation history DB 440, the second visual element 1044 is caused to display a result of determining whether to update the operation setting DB 446 on the basis of the operation history DB 440. According to such a configuration, the user can check the update of the operation history DB 440 and the content of the result of the update determination of the operation setting DB 446 based on the operation history DB 440 in real time.

### Second Embodiment

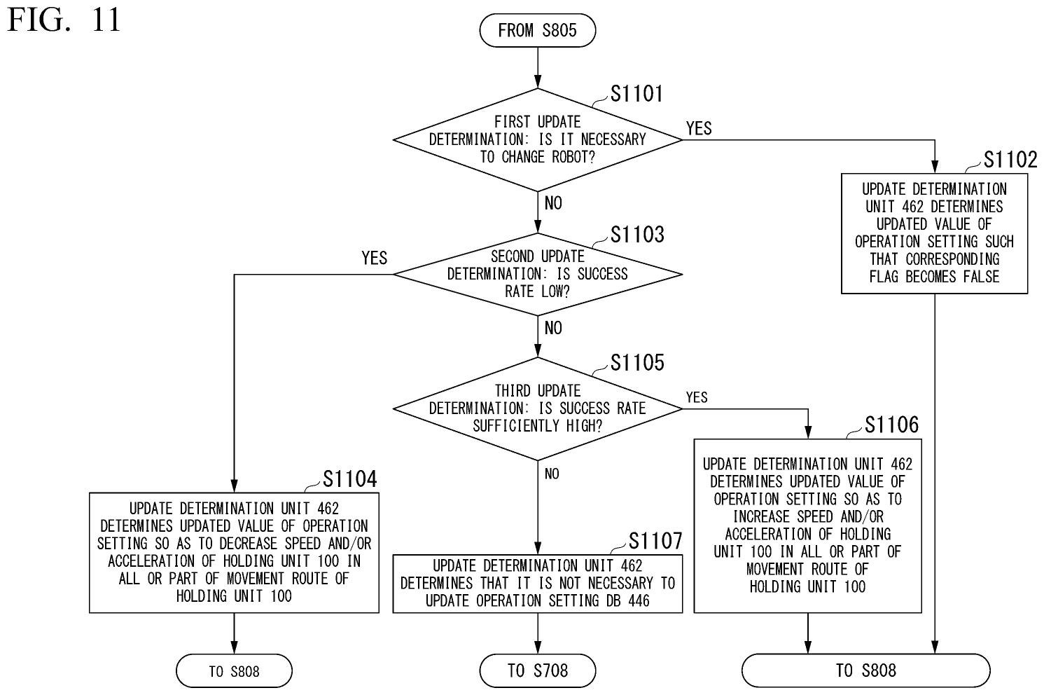

Next, a picking system 1 according to a second embodiment will be described with reference to FIG. 11.

FIG. 11 is a flowchart which shows processing in which an update target determination unit 464 according to the second embodiment determines an update target.

The second embodiment differs from the first embodiment in that the update determination unit 462 performs a “third update determination” that is different from the first update determination and second update determination described in the first embodiment. In the following description, differences from the embodiment described above will be mainly described, and description of common points with the embodiment described above will not be repeated.

A flow of processing in the second embodiment is similar to the flow described in the first embodiment with reference to FIGS. 7 and 8. However, specific processing content of steps S806 and S807 in FIG. 8 is different from the processing content of the first embodiment (refer to FIG. 9). FIG. 11 shows specific processing of steps S806 and S807 in the second embodiment.

In the flow shown in FIG. 11, contents of steps S1101 to S1104 are the same as in the first embodiment. In a case in which the update determination unit 462 determines in the second update determination in step S1103 that the success rate of a next picking operation is not low (NO in step S903), the update determination unit 462 performs a third update determination in step S1105. In the third update determination, for example, the update determination unit 462 determines whether the success rate of a next picking operation is sufficiently high. For example, similarly to the second update determination, the update determination unit 462 uses the first information S1 on the next picking operation as a key to search for past operation records whose first information is S1 from the operation history DB 440. The update determination unit 462 can calculate the number of occurrences or the frequency of occurrence of a failure, a failure sign, or a similar result in these operation records that share the first information S1, and can use a result of the calculation as a basis for determination. For example, the update determination unit 462 can calculate the number or frequency of operation records in which a picking operation has succeeded but a failure (or a failure sign) has been detected among the most recent predetermined number of operation records whose first information is S1 as a failure index (or a failure sign index). In addition, the update determination unit 462 can calculate the number or frequency of operation records for which picking operation control has been retried in the most recent predetermined number of operation records whose first information is S1 as an execution retry index.

The update determination unit 462 can determine that the success rate of a next picking operation is sufficiently high (YES in step S1105) in a case in which the failure index is equal to or less than a predetermined threshold value, the failure sign index is equal to or less than a predetermined threshold value, and the execution retry index is equal to or less than a predetermined threshold value. For example, in a case in which both threshold values are set to 0, the update determination unit 462 determines that the success rate of a next picking operation is sufficiently high in a case in which the failure index, failure sign index, and execution retry index are all 0. In this case, in step S1106, the update determination unit 462 determines the updated value of the operation setting so as to increase the speed and/or acceleration of the holding unit 100 in all or a part of the movement route of the holding unit 100. As a result, it is possible to speed up the operation of the holding unit 100 in cases where there are very few or no failures, failure signs, or retries. As a result, it is expected to improve the efficiency of the picking operation by accelerating the operation of the holding unit 100 in a case in which it is performing excessively careful operations. Then, the flow proceeds to step S808 in FIG. 8.

Here, specific processing content of step S1106 will be further described using an example.

For example, the update determination unit 462 can increase the maximum speed by, for example, 10% in a case in which there has been no drop in the most recent b time operation records for each of the item 60 dropping into the first housing unit C1, dropping into the second housing unit C2, or dropping outside the housing units C1 and C2. However, in a case in which the update determination unit 462 has decreased the maximum speed according to the second update determination in the past, it is preferable that the update determination unit 462 will not increase the maximum speed to a value equal to higher than the speed at the time of the determination.

In a case in which the holding method is pinching, the operation determination unit 366 can determine whether an event has occurred during the transport operation of the item 60, in which the change in opening amount of the pinching claw 134 is equal to or greater than a threshold value between the two predetermined via-points P1 and P2 that constitute the movement route, and transmit a result to the management device 40 as operation records. In a case in which the event described above is not detected c times or more among the most recent b time operation records, the update determination unit 462 can determine that the holding state during the transport is sufficiently stable, and increase the maximum speed by, for example, 10%. However, in a case in which the update determination unit 462 has decreased the maximum speed according to the second update determination in the past, it is preferable that the update determination unit 462 will not increase the maximum speed to a value equal to or higher than the speed at the time of the determination.

In a case in which the holding method is adsorption, the operation determination unit 366 can determine whether an event has occurred during the transport operation of the item 60, in which the change in suction force detected by the adsorption unit sensor 146 is equal to or greater than a threshold value between the two predetermined via-points P1 and P2 that constitute the movement route, and transmit a result to the management device 40 as operation records. In a case in which the event described above is not detected c times or more among the most recent b time operation records, the update determination unit 462 can determine that the holding state during the transport is sufficiently stable, and increase the maximum speed by, for example, 10%. However, in a case in which the update determination unit 462 has decreased the maximum speed according to the second update determination in the past, it is preferable that the update determination unit 462 will not increase the maximum speed to a value equal to or higher than the speed at the time of the determination.

On the other hand, in a case in which the failure index, failure sign index, and execution retry index exceed a predetermined threshold (for example, values exceeding 0), the update determination unit 462 can determine that the success rate of a next picking operation is not sufficiently high (NO in step S1105). In this case, in step S1107, the update determination unit 462 determines that it is not necessary to update the operation setting DB 446. The flow then proceeds to step S708 in FIG. 7.

In this manner, the update determination unit 462 updates the operation setting DB 446 to increase the speed and/or acceleration of the holding unit 100 during a picking operation in a case in which it is determined that the success rate is sufficiently high in the third update determination. As a result, the picking system 1 can improve the efficiency of the picking operation by speeding up the operation of the holding unit 100 in a case in which a movement of the holding unit 100 is excessively slow. After that, in a case in which the moving speed of the holding unit 100 becomes excessively fast, the update determination unit 462 updates the operation setting DB 446 to slow down the operation of the holding unit 100 again according to the second update determination. By repeating this, it is possible to optimize the operation setting related to the speed and acceleration of the holding unit 100 in the operation setting DB 446.

Note that the update determination unit 462 may also increase the recommended holding score for the currently selected operation setting by a predetermined amount or ratio in addition to or instead of updating the speed and/or acceleration of the holding unit 100 in a case in which the failure index is equal to or less than a predetermined threshold, and the failure sign index is equal to or less than a predetermined threshold (for example, in a case in which the failure index and failure sign index are 0). As described above, it is possible to increase the success rate of the picking operation by updating the operation setting DB 446 to preferentially use operation settings with a higher success rate.

In the present embodiment, the update determination unit 462 performs the third update determination of determining whether to update the operation setting DB 446 so as to increase the speed and/or acceleration of the holding unit 100 in all or a part of the movement route of the holding unit 100. According to such a configuration, in a case in which there are sufficiently few failures and retries, the operation of the holding unit 100 may be excessively slow. Accordingly, the picking system 1 speeds up the operation of the holding unit 100 to improve the efficiency of a picking operation.

In the embodiment described above, the update determination unit 462 determines the updated value of the operation setting DB 446 and the update target determination unit 464 determines the update target on a rule basis, but these types of processing may also be executed using a machine-learned model. The updated value of the operation setting DB 446 may be determined by using, for example, a learned model that has learned a relationship between conditions under which the update determination unit 462 determines to update the operation setting DB 446 and the update method of the operation setting DB 446. The update target may be determined by using, for example, a learned model that has learned a relationship between the conditions under which the update determination unit 462 determines to update the operation setting DB 446 and an index for selecting the update target.

In each embodiment, processing in the control device 30, the management device 40, and the user terminal 50 is assumed to be realized by using program software in an external storage device such as a memory using one or more processors such as a central processing unit (CPU), but may also be realized by hardware (for example, circuitry) that does not use a CPU. In addition, processing may be executed via a cloud server.

Instructions shown in processing procedures shown in each embodiment can be executed on the basis of a software program. The same effects as those obtained by the processing procedures described above can be obtained by a general-purpose computer system reading a program stored in advance. The instructions described in each embodiment are recorded, as a program that can be executed by a computer, in magnetic disks (a flexible disk, a hard disk, and the like), optical disks (a CD-ROM, a CD-R, a CD-RW, a DVD-ROM, a DVD+R, a DVD+RW, a Blu-ray (registered trademark) disc, and the like), a semiconductor memory, or a similar recording medium. A storage format of the recording medium may be any format as long as it is a recording medium that can be read by a computer or an embedded system. The computer reads the program from this recording medium and causes the CPU to execute instructions described in the program on the basis of this program, thereby realizing operations similar to the processing procedures described above. The computer may acquire or read a program through a network.

Middleware (MW) such as an operating system (OS), a database management software, and a network may also execute a part of the processing procedures on the basis of instructions from a program installed from a recording medium into a computer or embedded system. The recording medium in each embodiment is not limited to a medium independent of the computer or the embedded system, but also includes a recording medium in which a program transmitted via a LAN or the Internet is downloaded to be stored or temporarily stored. The number of recording media is not limited to one, and processing may be executed from a plurality of media. Such a recording medium may have any configuration.

The computer or embedded system in each embodiment is a device for executing each type of processing in each embodiment based on the program stored in the recording medium, and may be any constituent of a single device such as a personal computer or a microcomputer, and a system in which a plurality of devices are connected via a network. The computer in each embodiment is not limited to a personal computer, but also includes an arithmetic calculation processing device, a microcomputer, and the like included in an information processing apparatus, and is a general term for apparatuses and devices that can realize functions in each embodiment by using a program.

According to at least one embodiment described above, the efficiency of a picking operation can be improved by determining whether to update the operation setting DB 446 on the basis of a plurality of operation records included in the operation history DB 440.

Each functional unit such as the acquisition unit, processing unit, storage unit, and output unit described in the example described above is a functional unit that is realized by hardware constituents including a processor, a memory, a storage, an input or output interface, a communication interface, and a bus that interconnects these of a control device in cooperation.

Although several embodiments of the present invention have been described, these embodiments are presented as examples and are not intended to limit the scope of the invention. These embodiments can be implemented in various other forms, and various omissions, substitutions, and changes can be made within a range not departing from the gist of the invention. These embodiments and their modifications are included in the scope and gist of the invention as well as in the scope of the invention described in the claims and its equivalents.

What is claimed is:

1. A handling system that handles an object, comprising:
a holding unit configured to hold the object;
a storage unit configured to store operation setting information and operation history information, wherein the operation setting information associates first information entailed in a holding operation in which the holding unit holds the object, with second information including an operation setting for operating the holding unit, and wherein the operation history information includes operation records of the holding unit; and
a processing unit configured to:
control an operation of the holding unit on the basis of the operation setting information,
update the operation history information on the basis of operation records of the operation, and
determine whether to update the operation setting information on the basis of the updated operation history information.

2. The handling system according to claim 1,
wherein, in a case in which it is determined to update the operation setting information for particular first information, the processing unit determines whether to update the operation setting information for other first information.

3. The handling system according to claim 2,
wherein the processing unit determines whether to update the operation setting information for the other first information at least on the basis of one or more of attributes of the object, location of the object, attributes of the holding unit, and location of the holding unit in the particular first information and the other first information.

4. The handling system according to claim 1,
wherein the processing unit evaluates a result of operation control of the holding unit, and
the operation history information includes information of evaluation of the operation control.

5. The handling system according to claim 4,
wherein the processing unit determines whether there has been a sign of a failure in the operation control of the holding unit, and
the information of evaluation includes information indicating whether there has been a sign of a failure.

6. The handling system according to claim 4,
wherein the processing unit determines whether to update the operation setting information on the basis of the number or frequency of appearance of a particular evaluation in the operation history information.

7. The handling system according to claim 1,
wherein the processing unit performs a first update determination of determining whether to update the operation setting information to change the holding unit that performs a handling operation.

8. The handling system according to claim 1,
wherein the processing unit performs a second update determination of determining whether to update the operation setting information so as to decrease a speed and/or acceleration of the holding unit on a movement route of the holding unit.

9. The handling system according to claim 1,
wherein the operation history information includes retry information indicating whether the processing unit has retried processing for a handling operation, and
the processing unit determines whether to update the operation setting information at least on the basis of the retry information.

10. The handling system according to claim 9,
wherein the processing unit determines to update the operation setting information in a case in which the number or frequency of retries is equal to or greater than a threshold value.

11. The handling system according to claim 1,
wherein the processing unit performs a third update determination of determining whether to update the operation setting information so as to increase the speed and/or acceleration of the holding unit on all or a part of the movement route of the holding unit.

12. The handling system according to claim 1,
wherein the operation setting information includes critical value information that specifies an upper limit value and/or a lower limit value of a physical quantity related to the operation control of the holding unit, and
the processing unit updates the critical value information in a case in which it is determined to update the operation setting information.

13. The handling system according to claim 1,
wherein the operation setting information includes change pattern information that specifies a change pattern of a physical quantity related to the operation control of the holding unit, and
the processing unit updates the change pattern information in a case in which it is determined to update the operation setting information.

14. The handling system according to claim 1,
wherein the operation setting information includes position posture information that specifies a position and/or a posture of the holding unit, and
the processing unit updates the position posture information in a case in which it is determined to update the operation setting information.

15. The handling system according to claim 1,
wherein the operation setting is a default setting in the operation control of the holding unit.

16. An information processing device that manages a handling system including a holding unit for holding an object, comprising:
a processing unit configured to:
acquire operation records of the holding unit,
update operation history information including operation records of the holding unit on the basis of the acquired operation records, and
determine whether to update operation setting information on the basis of the updated operation history information, wherein the operation setting information associates first information entailed in a holding operation in which the holding unit holds the object, with second information including an operation setting for operating the holding unit.

17. A method of managing a handling system that includes a holding unit for holding an object, comprising:
by a computer,
acquiring operation records of the holding unit;
updating operation history information including operation records of the holding unit on the basis of the acquired operation records; and
determining whether to update operation setting information on the basis of the updated operation history information, wherein the operation setting information associates first information entailed in a holding operation in which the holding unit holds the object, with second information that includes an operation setting for operating the holding unit.

18. A non-transitory computer readable storage medium that stores a program for a handling system,
wherein the program causes a computer to execute the method according to claim 17.

19. An information processing system that causes a display unit to display information of a handling system including a holding unit for holding an object, comprising:
a processing unit configured to:
cause the display unit to display a first visual element related to operation history information and a second visual element related to operation setting information, wherein the operation history information includes operation records of the holding unit, and wherein the operation setting information associates first information entailed in a holding operation in which the holding unit holds the object, with second information including an operation setting for operating the holding unit,
acquire operation records of the holding unit,
cause the first visual element to display the operation history information to which the acquired operation records are added in response to the acquisition of the operation records, and
cause the second visual element to display a result of determining whether to update the operation setting information on the basis of the operation history information in response to the addition of the acquired operation records to the operation history information.

20. A non-transitory computer readable storage medium that stores a data structure for a handling system including a holding unit for holding an object and a control unit for controlling the holding unit, the data structure comprising:
operation setting information associating first information entailed in a holding operation in which the holding unit holds the object, with second information including an operation setting for operating the holding unit; and
operation history information including operation records of the holding unit,
wherein the data structure is used for processing in which the control unit controls an operation of the holding unit on the basis of the operation setting information, updates the operation history information on the basis of operation records of the operation, and determines whether to update the operation setting information on the basis of the updated operation history information.
